(19) United States
(12) Patent Application Publication
(10) Pub. No.: US 2012/0036007 A1
(43) Pub. Date: Feb. 9, 2012

(54) Creating, Managing and Optimizing Online Advertising

(76) Inventors: Niel ROBERTSON, Boulder, CO (US); Chris BURTON, Boulder, CO (US); Tom GUZIK, Boulder, CO (US); Jeff OSBORN, Boulder, CO (US); Michael LAWLESS, Boulder, CO (US); Bill QUINN, Boulder, CO (US); Seth LEVINE, Boulder, CO (US); Matt HESSLER, Boulder, CO (US); David MITCHELL, Boulder, CO (US)

(21) Appl. No.: 13/051,843

(22) Filed: Mar. 18, 2011

Related U.S. Application Data
(63) Continuation of application No. 12/832,568, filed on Jul. 8, 2010.

(51) Int. Cl. G06Q 30/02

(52) U.S. Cl. 705/14.43; 705/14.48

(57) ABSTRACT

Systems and methods for creating, managing and optimizing online advertising campaigns include groups of independent human resources working through a marketplace to suggest and optimize appropriate choices for how, where and how much to pay for online advertising. Optimization is achieved through the use of market-based incentives that pay participants based on the quality, quantity and efficiency of the results of their suggestions. The systems and methods enable a marketplace that leverages the inherent knowledge of a large group of people to come up with all search terms, placements, targeting and advertisements that might be relevant to a product, and determine the optimal auction prices for these search terms, placements, targeting and ads on the search engine systems.

### RELATED APPLICATIONS

This application is a continuation of U.S. patent application Ser. No. 12/832,568, filed Jul. 8, 2010.

### TECHNICAL FIELD

The present invention relates generally to tools designed to help advertisers create, manage and optimize online advertising.

### BACKGROUND

Online advertising has become a primary source of branding, traffic and lead generation for businesses in almost every category. With the increased amount of advertising spend online, the number of outlets and options for advertising has increased proportionately. With increased choice, the task of deciding how to advertise (what form of advertising), where to advertise (in each advertising category there are multiple options for the same type of ads), and how much to pay for advertising has become burdensome. This increased choice leads to increased complexity, and quickly advertisers have become overwhelmed by the sheer scale of advertising online.

Two classes of online or internet advertising include paid search and display advertising. Paid search advertising is the process of advertising next to search results on search engines such as Google, Yahoo, Microsoft Live/MSN/Bing, Ask.com, etc. When a user searches for something, advertisements related to that search are displayed alongside (e.g., in a sidebar) the search results. In general, an advertiser only pays a price for their advertisement when a user clicks on one of these sidebar ads. Display advertising encompasses a broad range of options to place text or graphical banner ads on or adjacent to relevant content (e.g., blogs, mobile applications, social network pages, online newspapers, embedded in videos, etc.). In general, display advertising works by charging the advertiser a fixed rate for a number of impressions (when their ad is physically viewable by a user) or when users click on or interact with a display advertisement.

There are multiple mechanisms of payment within each type of advertising. The common characteristic of the mechanisms of payment is that payment is based on measurable metrics. Common payment schemes are by impressions (CPM), by click (CPC), by conversion (CPA), by generated phone call (Pay Per Call), by completed download, or by installation (such as installing a mobile application on an iPhone).

To understand the complexity involved in online advertising, consider in more detail how one form of advertising, paid search, really works. The first thing an advertiser does is decide with which search terms they want their ad to appear. By way of example, imagine an advertiser who is selling cell phones through an online store. They want users to click on their ads, be directed to their website and then consummate a purchase through their online store. This advertiser would instruct the search engine having a paid search mechanism that they want their ads to appear with or alongside all search terms that might be relevant to their ads. In this example, example search terms might include “cell phone”, “cellphone”, “mobile phone”, etc. But there are a number of other search terms with which the advertiser might want their ads to appear. For example “sms”, “text messaging”, “iphones”, “GSM phones”, “smart phones”, “cell phone sale”, “cheap cell phones”, and “phone auctions”, to name a few. Considering the complete list of these search terms, it becomes apparent that there might be hundreds, thousands, or even tens of thousands of possible user search terms that would be relevant to an advertiser's products. For larger advertisers that carry many products (such as a large retail store), the list of relevant search terms for all products they carry could be in the millions.

Search engines decided to show one advertiser's ad versus another advertiser's ad, with particular search results, by holding an effective auction for the number of ad slots on a search results page. If there are 10 advertisers wanting to sell cell phones, each of them submits a bid price to the auction. The highest bidder will be displayed as the top advertisement on a search results page, the next highest bidder in position two and so on. Now consider that the search engine runs a separate auction for every possible search term that a user could input. This means an advertiser would be required to participate in hundreds or maybe even millions of auctions to cover all search terms with which they want to appear. To make matters worse, these auctions run 24 hours a day, 7 days a week.

Adding further to the complexity is how well users respond to the actual ad. While an advertiser may receive the top advertising slot through a high bid, if their advertisement is not attractive to the user, the user will not click on it. Using the cell phone example above, imagine how many types of ads could be conceived to attract a cell phone buyer: ads focused on discounted products, ads focused on the newest cell phones, and ads claiming the advertiser has a huge inventory of GSM phones, to name a few. Not only is it hard to conceive all possible ads that might attract a user, matching them with the millions of search terms with which they might appear is a massively complex task.

As another layer of complexity, the major search engines (e.g., Google, Yahoo, Microsoft Live) run their own advertising systems which have varying auction prices for the same search term. An advertiser may find that on one search engine the price of the top advertising slot for the search term “cell phone” is $2.00 while on another search engine it is only $1.50. Deciding which search terms to use on which networks to make the most efficient use of advertising dollars is thus very complex.

To make matters even more complex, each advertiser has a limited amount of money they can spend on advertising to achieve a profitable goal. This goal might be the cost to attract a new visitor, the cost to have a visitor register on their site, the cost to reach a certain size and type of audience with their brand message, or the cost to consummate a sale. Not only does the advertiser have to deal with the complexity of building a campaign and participating in all the auctions, they must optimize the resulting costs against their acceptable business goals. In the case of search engine advertising this requires attention to each keyword used and to each ad contemplated.

Considering an alternative form of advertising, such as display advertising, the advertiser has both the challenge of selecting from thousands (or tens of thousands) of choices where to advertise (e.g., every web page or video is a potential discrete choice in inventory) and the challenge of targeting their advertising to the right consumers (e.g., by a demographic profile on a social network). Each individual location or profile may have a different price based on the demand for this inventory from other advertisers and may also have different outcomes for each advertiser based on the relevancy of their ads or the consumer they are reaching with that location or profile. In the same way that an advertiser has to select and price thousands of keywords in paid search and then match them to the right ads, an advertiser using display advertising must do the same with each unit of location and targeting inventory available.

As a result of these complexities, many advertisers do their best with only a few search term bids on only one search engine or a few obvious placements (e.g., websites) on which to run their banner ads. Most large advertisers who cannot afford to hire someone to do this in-house as a full time job instead hire an advertising agency that may specialize in performance-based online marketing. While this agency may have in-house resources that understand the various forms of advertising systems, they simply cannot put enough person-hours on each advertiser to handle the complexity of thousands of auctions, hundreds of ads, and efficient spend choices across multiple search engines and locations. So they resort to a similar approach of focusing on a few search terms or placements in the most obvious places that will at least drive some volume and a predictable (if but costly) flow of prospects to the advertiser's website.

One of the primary issues with addressing the advertising complexity problem (and the massive market inefficiency that results from it) is that the process of determining the right search terms or placements to advertise with and the right ad copy to match to it to attract clicks is a process that requires human cognition. While computer algorithms may be good at picking the right bid prices in each auction, they are not so good at writing an attractive text ad that encourages a user to click on the ad.

While there are many different types of performance-based online advertising campaigns, they share a number of similar concepts and an approach to their optimization that can be generalized into a consistent problem. The core concepts they share are described below.

Each advertising type (such as paid search, display advertising, mobile, etc.) has one or more allowed forms and formats of advertisement that encapsulates the advertisers message and call to action. This might be a text advertisement such as on Google.com, a graphic banner advertisement, a small video, audio, interactive media widget, or even an interactive game. Different mediums require different types of ad copy, mechanisms to get attention (e.g., graphics) or calls to action (e.g., click a button, complete a game). The variations in this ad copy are usually limitless within the constraints of the format (e.g., number of allowed characters in a text ad, size of a banner ad, etc.).

Each advertisement type can redirect a user to another destination if it is interacted with (e.g., clicking on a text ad takes the user to a web page, winning a game advertisement takes the user to a web page, clicking a link connects the customer with the advertiser over a managed phone connection, etc.).

Each advertisement type can be targeted (e.g., shown to a specific user or subset of users) by the use of one or more types of targeting information. For example, in paid search, an advertiser uses keyword matching to target the advertisements they have to users who are declaring interest in their products via what they type into the Google search engine. In Facebook, an advertiser can decide to only show their advertisements to men or woman between the ages of 18 and 23. In a display advertising network (banner ads), the advertiser can select to only show their ads on specific web pages or domains (e.g., anywhere on engadget.com) where they believe their consumers browse the web. There are many forms of targeting which might also include age, gender, geographic location, time of day, previous web site browsing or search history, etc.

Each targeting is accompanied with a specific price that the advertiser is willing to pay for that targeting. The price determines, usually through a marketplace or auction model, how prominently or frequently the advertisement is display for that targeting. Different prices can be set for different types of targeting. In paid search an electronics advertiser may choose to spend $0.50 if their ad is show to and clicked on by someone who types in “digital cameras” but only $0.30 for someone who searches and clicks on “used digital cameras”. In a display network, the advertiser might choose to pay $0.50 for someone who clicks their display ad on engadget.com but only $0.30 for a click from MyUsedCameraBlog.com.

Optimization of the campaign against specific metrics (target cost of acquiring a customer, cost per click, volume of clicks in a day, etc.) can be performed by changing each of the variables described above in a very fine tuned basis (e.g., by changing bid prices keyword by keyword, or by pricing “placements” in a display network URL by URL, or by varying ad copy to something that attracts more consumers).

### BRIEF DESCRIPTION OF THE DRAWINGS

FIG. 1 is a block diagram of the advertising management system (AMS), under an embodiment.

FIG. 2 is a flow diagram for creating, managing and optimizing online advertising campaigns using the AMS, under an embodiment.

FIG. 3 is a block diagram of click routing using the AMS, under an embodiment.

FIG. 4 is a block diagram of click routing and conversion tracking using the AMS, under an embodiment.

FIG. 5 is a block diagram of PPA payouts using the AMS, under an embodiment.

FIG. 6 shows another PPA example scenario using the AMS, under an embodiment.

FIG. 7 is an example Campaign Manager web page of the AMS, under an embodiment.

FIG. 8 is an example Create An Ad web page of the AMS, under an embodiment.

### DETAILED DESCRIPTION

Systems and methods for creating, managing and optimizing online advertising (ad) campaigns are provided. The systems and methods of an embodiment use groups of independent human resources working through a marketplace to suggest and optimize appropriate choices for how, where and how much to pay for online advertising. Optimization is achieved primarily through the use of market-based incentives that pay participants based on the quality, quantity and efficiency of the results of their suggestions. More particularly, the systems and method enable the collaborative building and managing of performance-based advertising campaigns such a paid search (referred to herein as pay-per-click (PPC)), display and banner, content network (e.g., text-based display advertising such as Google AdSense), mobile application, video, rich media, social media (e.g., social networks such as Facebook, Twitter and Digg), demographic/profile targeted, SEO, and other forms of online advertising.

The embodiments described herein generalize the activity of performance-based marketing to the selection, testing, management, and optimization of specified variables and the matching process between targeting, advertisement, and destination. The embodiments provide a generalized approach to using a large group of people to build, price, manage, and optimize online advertising campaigns. These people (referred to herein as optimizers) work collaboratively and competitively on a campaign through a marketplace dynamic that organizes them and manage their compensation based on preset pay for performance metrics set by the advertiser. Campaigns running through this market effectively have tens or hundreds of people working on them at the same time, as opposed to one singular manager. The embodiments comprise both the organization of this group as well as the deployment of their work to ad networks either as individual campaigns or the merging of their work into singular comprehensive campaigns. The definition of “individual” or “merged” is taken from the perspective of the ad network (e.g., Google, Yahoo, Facebook, YouTube, a blog, etc.) in the sense that they perceive either one comprehensive campaign to be running or multiple smaller ones to be running simultaneously.

The embodiments described herein include systems and methods that establish or provide a marketplace that leverages the inherent knowledge of a large group of people to come up with all search terms, placements, targeting and ads that might be relevant to a product, and determine the optimal auction prices for these search terms, placements, targeting and ads on the search engine systems. These individuals are incentivized to contribute their knowledge and do the work required to find optimal pricing and placement through use of a marketplace mechanism that pays them proportionately to their success. Advertisers are able to abstract their campaigns down to the basic relevant metrics: the price they are willing to pay for a specific result (click, conversion, CPM), their budget, and the ads they want to run. The resulting advertising campaign is broader in its scope (e.g., encompasses more search terms, placements, locations and ads than one individual is likely to think of themselves) and more efficient in its use of money (e.g., the overall cost of the campaign is reduced). In addition the advertiser does not have to do the work themselves and does not have to employ, manage and evaluate the individuals doing the work.

In the following description, numerous specific details are introduced to provide a thorough understanding of, and enabling description for, embodiments herein. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The following terms are intended to have the following general meanings as they are used herein, but are not limited to these general meanings as the terms comprise all definitions of these terms known to those skilled in the art.

“Pay Per Click” (PPC) is a form of advertising in which the advertiser only pays when a user clicks on one of their ads.

“Pay Per Action” (PPA) is a form of advertising in which the advertiser only pays when a user finalizes an action they have defined (e.g., buys something from the advertiser's website).

“Sticky Click” is a form of variable payment based on paying optimizers for acquiring visitors with a certain predefined set of characteristics such as the number of pages they visit on a website, how long they view the web site, etc.

“Search Engine Marketing” (SEM) is a form of online advertising in which advertisers place their advertisements on search results pages for search terms they think relevant to their products.

“Display Advertising” is a form of online advertising where an ad is placed on a website, blog, video, mobile application, etc. and the advertiser pays based on the number of users that see the advertisement.

An “optimizer” is an individual who participates in the marketplace by suggesting appropriate attributes of advertising such as placement, search terms, pricing, etc.

An “advertiser” is someone who is spending money on online advertising using one or more different advertising methods.

A “conversion”, also referred to as an “action”, is when a web site user performs some act desired by the advertiser (e.g., complete a purchase, download a product overview, register for a newsletter, etc.).

A “campaign” is a specific advertising activity in which there is a focus, time frame, set of ads, and pricing from the advertiser. An advertiser may have or be running one or more campaigns at any particular time.

A “market” is the marketplace created by the company that connects advertisers who want to run campaigns with optimizers who work on their campaigns.

“Stock ads” are ads an advertiser has created for use by an optimizer.

“Custom ads” are ads the optimizer can propose to the advertiser for use.

A “landing page” is a web site page or other internet location on which a searching or browsing user lands following clicking on an ad on a search engine results page or placement. The landing page is generally, but not required to be, on the advertiser's website and can be any page to which they are directed (e.g., homepage, specific product page, etc.). An advertiser is not limited in the number of landing pages used.

A “searcher” is a user who goes to a search engine (e.g., Google.com) to search for something The searcher may or may not click on advertisements returned adjacent to their search results.

A “bid price” is the price an advertiser is willing to pay for a click, a conversion, or any other mechanism in the market that creates a spread.

An “optimizer bid” is the price an optimizer tells the market they would like to bid for an activity (e.g., a click) on the search engine.

A “spread” is the difference between what an advertiser is willing to pay (e.g., the advertiser bid) and the price or cost at which it was actually delivered.

A “payout” is the amount of money paid to an optimizer when the optimizer beats the spread.

A “rake” is the fee withheld from the payout to an optimizer. The rake can be calculated according to various rules.

An “ad network” is a company that provides or one or more types of advertising such as a search engine that provides paid search advertising, a website that provides text and/or graphic banner advertising options, or a mobile application network that provides in-application advertising options

A “placement” is a unique location such as a web page, complete internet domain, mobile application, social network user page, or video that represents a unit of inventory that can be separately priced and managed.

A “target” is a combination of selected variables and their values used by an ad network to select which users (searchers, browsers) to show advertisements to.

One of the more complicated decisions that an online advertiser must make is where their advertising dollars are most effectively spent given their available options. Advertisers generally have two choices with regards to advertising: what type of online advertising to use (e.g., paid search, display, content, mobile, video, etc.) and which “network(s)” inside that advertising type do they want to use (e.g., in paid search do they want to use Google AdWord or Yahoo Search Marketing or Microsoft AdCenter or some combination of each).

It is hard for an advertiser to know up front with certainty which method(s) will be the most effective. As money is spent and various advertising types are tried, enough data will eventually be collected that the advertiser can calculate the exact return on advertising investment against the campaign goals. This might be a metric for the cost of a sale generated through this advertising, or it might be volume of web site visitors generated through clicks from the ads, or even impressions of the advertising. Regardless, one of the challenges for an advertiser is to constantly reapportion their budget between advertising types and network options within these types.

Embodiments described herein provide a mechanism for the advertiser to specify quantitative campaign targets, the types of advertising allowed, and any budget limits on an advertising type (paid search versus display) or advertising network (Google PPC versus Yahoo PPC). With these parameters specified, the marketplace then dynamically adjusts budget allocation between each of the advertising options allowed by the advertiser.

Online performance based marketing campaigns go through a number of phases. Initially, advertisers try using various targeting mechanisms (e.g., keywords, placements, etc.), ad copy, bid prices, etc. This phase can roughly be called “exploration” as the advertiser is exploring the different variables available to them trying to understand what works for their product or service. Once some data has been collected, the advertiser starts to hone the campaign and remove the elements of it that are clearly not working. For example, an advertisement on a specific placement may never result in a sale because the profile of the person reading that web page is not the profile of a customer appropriate to the advertiser. This phase is called “stabilization” and the goal is to start to reduce the variability of results by honing down what is being tried in the exploration phase. The last phase, once even more data is collected, is called optimization. This phase is a constant iterative process of adjusting bid prices and ad copy and other variables based on things that are working (getting sales for example) to find the optimal combination of variables to get the desired outcome (low cost sales, highest volume of visitors, etc.). In reality all of these phases are ongoing at the same time because data is not acquired consistently for every variable. For example, one targeting keyword might get 100 clicks on an ad very quickly and 20 of those clicks turn into sales. This is enough data to start optimizing the right pricing of that keyword. Another keyword might be searched on less frequently and it might take 3 months to determine if it is valuable to keep in the campaign. So the phases are always present and always running.

In the marketplace, the advertiser can define different payment mechanisms for each phase. In the exploration phase an advertiser might incentivize optimizers by paying them a spread on every click received. Advertisers want them to collect data and this incentive drives them towards that goal.

In the stabilization phase the advertiser may not want to pay an optimizer on every click (as there is enough data to know that something works) but perhaps pay them on a sale as that is the real focus of the campaign. Alternatively, the advertiser might be interested in quality visitors (visitors that spend a lot of time on the site) and might pay the optimizer variably based on the actions of the user once they clicked through the ad to the web site.

In the optimization phase, the advertiser might be solely focused on the cost of a sale and would be willing to pay the optimizer based on beating a target sale cost. The market provides the mechanism to change the payment structure for each phase so that it is aligned with the advertiser's goals in that phase.

The embodiments described herein include a system for running different types of phases (and payment mechanisms) in the marketplace as well as the ability to run more than one phase at the same time on the same campaign. An advertiser could set up a campaign in the market as solely exploration related. This could be the only phase available and the payment structure could be focused on a purely click-based model. More importantly an advertiser could set up a campaign as having all three phase types (and payment mechanisms) and simply apportion their budget to each of the phases given the length of time the campaign had been running In the beginning the campaign could be 100% exploration, 0% stabilization and 0% optimization. As data is collected the advertiser might introduce the stabilization phase (and payout mechanism) and change the budget to 60/40/0%. As even more data is collected the advertiser could introduce the third stage of optimization and shift the budget to focus on that by setting it to 20/20/60%.

Regardless, the optimizer is responsible for deciding which phase in which to run some of their campaign work. While the advertiser might set up requirements for entry into each phase (e.g., 5 required sales before the optimization phase can be entered for an optimizer), ultimately it is up to the optimizer to decide the best phase/payment mechanism given the amount of data and confidence they have in a portion of their work. Optimizers could run different parts of their work in different phases and different optimizers could have different strategies. Another element of an embodiment is a set of advertiser goals and requirements for each stage and an enforcement that says if an optimizer's results in a phase do not meet one or more of these specific phase goals, they will not be able to play in that phase (and must revert to playing in another phase that has easier goals to meet).

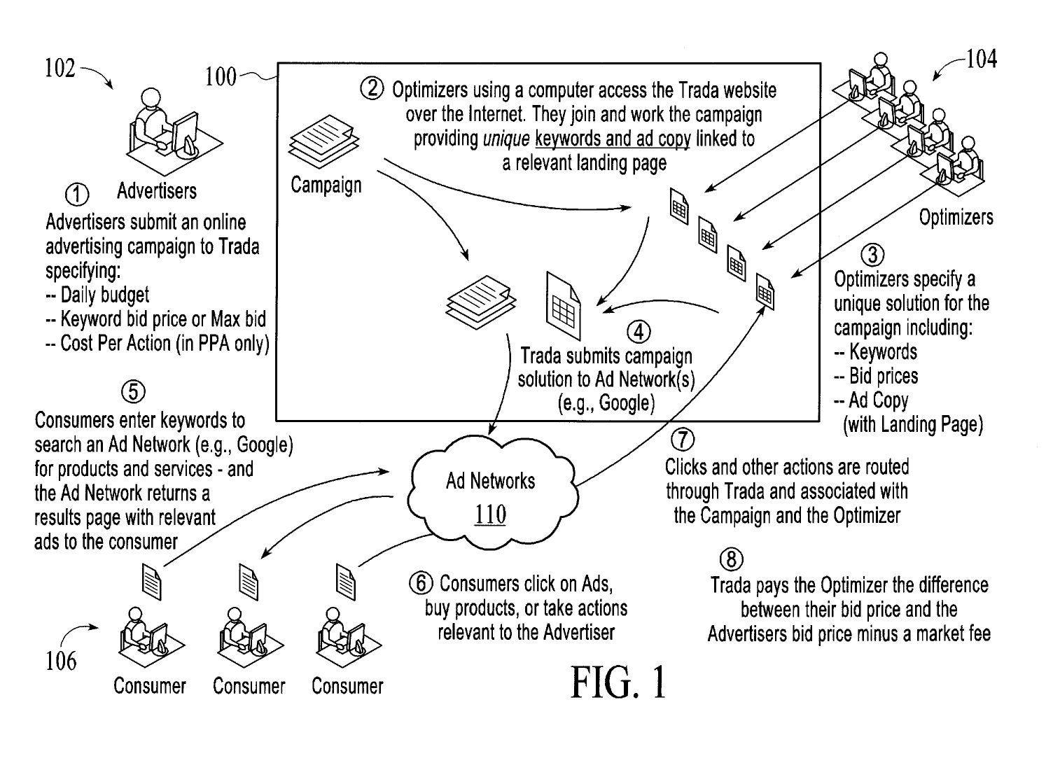

FIG. 1 is a block diagram of the advertising management system (AMS), under an embodiment. The AMS includes an AMS platform 100 coupled to advertisers 102, optimizers 104, and consumers 106 via a network 110. The network 110 can be one or more of a public network (e.g., internet) and a proprietary network. The AMS of an embodiment comprises a processor coupled to a database and one or more of the following components, but is not so limited: the advertiser's bid price and campaign settings; the collection of ads available to put onto search engines or other types of advertising networks (such as those allowing graphical display ads); the optimizers' choices of search terms or placements, ads, search engine and search term auction prices or per-placement prices; the resolution of optimizer suggestion conflicts; the enforcement of terms of services; the management of the search engine or other types of advertising campaign; the routing of the searching or browsing user through the company's systems when they click on an ad; and the spread payout mechanism. Each of the components of the AMS is described in detail below.

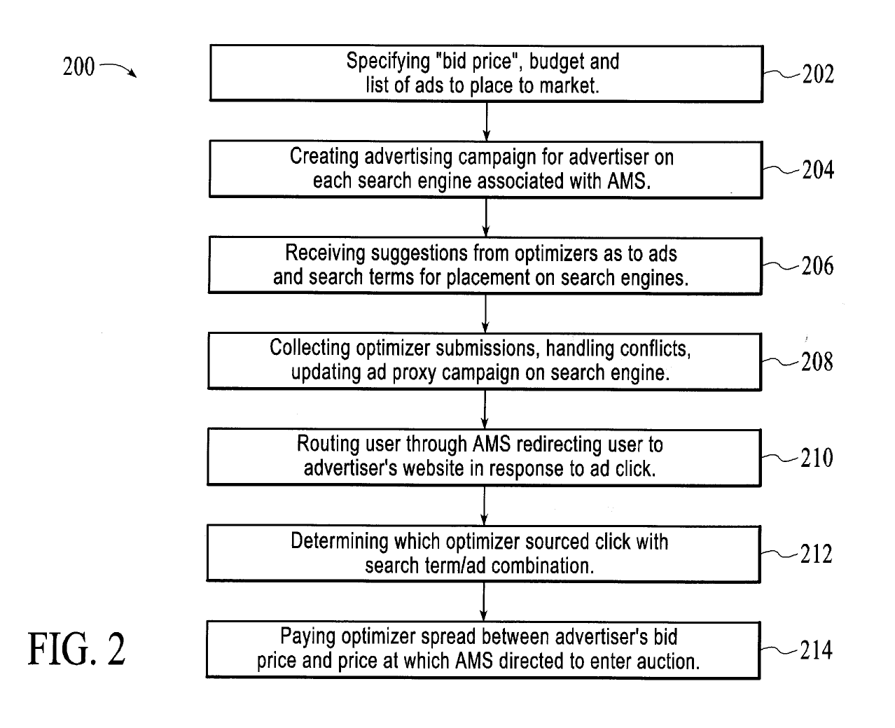

FIG. 2 is a flow diagram for creating, managing and optimizing online advertising campaigns 200 using the AMS 100, under an embodiment. With reference to FIGS. 1 and 2, the advertiser specifies their “bid price”, budget and list of ads to place to the market 202 (also see FIG. 1, element 1). The AMS 100 creates or generates an advertising campaign for the advertiser on each search engine or ad network with which the AMS 100 works or has associations 204 (also see FIG. 1, element 4). One or more optimizers suggest to the market maker (AMS 100) that they would like to place certain ads and search terms or placements at a specified price (under the advertisers bid) on a specific search engine or ad network (limited to the search engines with which AMS 100 works) 206 (also see FIG. 1, elements 2 and 3). The AMS 100 collects all optimizer submissions, handles any conflicts (described in detail below) and updates the advertiser's proxy campaign on the search engine(s) or ad network(s) involved in that specific campaign 208 (also see FIG. 1, element 4). This updating process effectively submits the optimizer's bids into the auctions or purchasing mechanism for those search terms or placements.

When a user searches on a search term or browses a placement that has been submitted by an optimizer and one of the advertiser's ads is clicked, the user is routed through the AMS platform 100 and then is redirected to the advertiser's landing page 210 (also see FIG. 1, elements 5, 6, 7). This routing and redirection is seamless and unnoticeable to the searching user. The AMS 100 determines which optimizer sourced the click with the search term or placement and ad combination on that search engine or placement 212 (also see FIG. 1, element 8). While other models exist, a common payment model charges the advertiser their bid price by the AMS 100, and the optimizer is paid the spread between the advertiser bid price and the price at which they directed the AMS 100 to enter the auction 214 (also see FIG. 1, element 8). A percentage of the spread is paid to the AMS 100 as a market fee. The optimizers analyze their results, submit adjusted auction prices to the AMS 100, suggest new search terms and placement and prices for them, and the process continues dynamically 24 hours a day, 7 days a week.

Regarding the components of the AMS 100 that include the advertiser's bid price and campaign settings, when an advertiser 102 creates an advertising campaign using the AMS 100, they need to supply a few specific attributes of the campaign. Campaigns in the market can be run with one more type of payment system. Two common ones are PPC and PPA while other campaigns payment mechanisms (CPM, CPI) do exist. Under all models the optimizers 104 choose how to bid on individual search terms or placements and thus how to spend the advertiser's money for the campaign. In the PPC campaign the optimizer 104 is paid out on a spread between the advertiser's 102 bid price for a click and what the optimizer 104 can get it for. In the PPA campaign the optimizer 104 is paid out on a spread between what the advertiser 102 is willing to pay for a conversion and how much of the advertiser's money was spent by the optimizer 104 to get that conversion.

An approval type is also specified for the advertising campaign. Campaigns can be set up on the market with various mechanisms to allow optimizers to participate. An open campaign allows any optimizer 104 to participate on the campaign. An approval campaign requires the advertiser 102 approve every optimizer 104 (by looking at their statistics on the market). A limited campaign means the advertiser 102 hand-selects one or more optimizers 104 to put into the campaign.

Moreover, an advertising campaign includes bid price information. There are a number of ways that the advertiser 102 can set bid prices. In general this is the price that the advertiser 102 is willing to pay for some action, for example, the price an advertiser 102 is willing to pay for a click or a conversion. This bid price sets the upper limit of the spread, and may be changed over time. Under the PPC model the bid price is the amount that the advertiser 102 is willing to pay to receive a click thorough the marketplace. Under the PPA model the bid price is the price that an advertiser 102 is willing to pay for a conversion. The advertiser 102 may specify one or more conversions with different bid prices. The advertiser 102, in a PPA campaign, also specifies the PPA click price. The PPA click price is a maximum price that optimizers 104 can bid on keywords.

As ad networks us an auction marketplace to set prices, the cost of each keyword or placement can be quite variable. An obvious keyword that a lot of advertisers want to bid on in the auction (as they perceive a lot of searchers on Google will type it in when looking for their products) could be $5.00 per click while a less obvious keyword might be $0.50. A common placement (such as CNN.com) might have more people bidding to put their ads on it than a less common website (such as BoulderDailyNews.com). To compete effectively in the auction, a bidder (optimizer 104) must have a broad range of prices they can bid. The advertiser 102 may also specify a number of click bid price tiers such as $0.01-$0.50, $0.51-$1.50, $1.51-$4.00. If a click based tier is set up by the advertiser 102, optimizers 104 can bid anywhere between the lowest tier price ($0.01) in this example and the highest tier price ($4.00) in this example. The payment they receive when a click is achieved is calculated based on the tier into which their bid price falls. When a click occurs, the advertiser 102 pays the fixed price of the top of that tier, and the optimizer 104 makes the spread between the top of the tier their bid is in and the bid. Using the example above, an optimizer 104 that bids $1.00 on a keyword (thus falling in the $0.51-$1.50 range) would incur a cost from the advertiser 102 of $1.50 for the click and would themselves make $1.50−$1.00=$0.50 which is the spread created between their bid price and the top of the tier their bid price falls into.

The advertiser 102 may also specify conversion bid price tiers such as $0.00-5.00, $5.01-$10.00, $10.01-$12.00. If a conversion-based tier is set up by the advertiser 102, optimizers 104 can bid on individual keywords but they may target any conversion tier in which to receive their payout. The payment they receive when a conversion is achieved is calculated based on the tier into which their conversion cost falls. When a conversion occurs, the advertiser 102 pays the fixed price of the top of that tier, and the optimizer 104 makes the spread between the top of the tier their conversion price is in and the conversion bid.

Two other rules apply to tiered bidding. First, concerning the click-based bid tier, as the optimizer 104 does not know a priori what the cost of a click will be, they only get paid if they price the keyword in the correct tier. For example, an optimizer 104 may configure the AMS 100 to bid $0.60 to Google on a keyword but Google may only charge $0.40 for that click based on their auction model. Once a bid is submitted to the ad network they will return to the AMS 100 the actual price of the keyword once it was clicked. If the actual price is in a lower tier than the optimizer bid price, the optimizer 104 will make nothing, and the advertiser 102 will pay a fixed price for the top of the tier containing the actual price. The optimizer 104 will be shown this actual price and they can rebid into the correct tier. This prevents optimizers from “gaming the tiers” trying to find the biggest payout regardless of the correct price for the keyword bid.

The second rule is that the advertiser 102 can limit the payment percentage in each tier. At higher tier prices the absolute amount of money that can be made in the spread (e.g., $0.01-$0.50 has a 49 cent spread max while $1.51-$4.00 has a $3.49 spread) increases. This applies to both click-based tiers and conversion-based tiers. By adding a payment percentage factor to a tier (e.g., 50% payout) the absolute payment can be reduced. In the click example, if the top tier has a 25% payout, the max spread that could be made is $3.49*25%=87 cents. Any monies not paid to the optimizer 104 could be paid back to the advertiser 102 or to the marketplace. In a conversion tier system, if a conversion tier was $5.01-$10.00 with a 50% payout and the optimizer 104 got a conversion for $8.00 the payout would be $10.00−$8.00*50%=$1.

On top of other non-conversion based mechanisms (e.g., click, CPM, etc.) the embodiment includes a model for paying optimizers variably based on the characteristic of the visitors they drive to the advertiser 102. The advertiser 102 can predefine a target value for one or more set of variables that represent a visitor. These variables might be their bounce rate (how many of them view one page on the website then leave), time on site (what is the average time that a visitor spends on their site), new visitors versus old visitors (what percentage of traffic driven through the marketplace is new visitors), or any other metrics that can be discerned at the individual level (e.g., attributed back to each click in the marketplace). Once this metric is set, an optimizer's payment can be paid variably based on it.

For example take an advertiser 102 that has stated a required bounce rate of 40% (less than 40% of visitors bounce from the website). If an optimizer 104 has a 38% bounce rate, they may make the full payment to them through the click spread mechanism. If they achieved a 50% bounce rate, they may make less than 100% of the payment due to them based on some variable payment mechanism. As an example, consider a linear payment mechanism against bounce rate. If the optimizer 104 is above a 40% bounce rate, their payment is scaled based on the amount the stated bounce rate is exceeded. Since bounce rate can only be between 0% and 100%, if the target is 40% and the optimizer 104 achieved 50% the variable payment would be (100%−optimizer achievement)*(100%−advertiser achievement target). In this example that would be 50%/60%=83% of payout.

The advertiser 102 also determines a budget for their advertising. The advertiser's budget is an amount of money they are willing to spend per day in the marketplace for each campaign (across all search engines or placement ad networks). Under the PPA model this includes both search engine and placement spend (the cost of advertising on the search engine or placement ad network) and the conversion payouts.

The market works with a number of search engines and ad networks. Over time the number of search engines and ad networks will increase. The advertiser 102 has the ability to specify on which search engines and ad networks to allow advertising (e.g., Google but not Yahoo, TechCrunch but not Engadget) and what percentage of their budget they are willing to spend on each search engine or ad network. The advertiser 102 may also elect to have the market dynamically adjust the search engine and ad network split of spending based on real time data.

The advertiser 102, under an embodiment, may create one or more ads that can be selected by optimizers for use on the search engines and ad networks. These ads may be in many forms: text based ads, graphical banner ads, interactive ads, videos, sound, or games. Additionally, the advertiser 102 may specify whether they want optimizers to propose their own ads. If the advertiser 102 does allow this, they may elect to review and approve/reject every ad or have the ads automatically approved.

Regarding the components of the AMS 100 that include the collection of ads available for use in a campaign, an advertiser 102 creating a campaign on the market can specify one or more stock ads that they wish optimizers to use in the market. Any optimizer 104 working on the campaign can use one or more of these ads, and more than one optimizer 104 can use the same ad. While stock ads provide the advertiser 102 a mechanism to start the optimizers in the market, it is almost impossible for the advertiser 102 to think of all the possible advertisements that might be attractive to someone searching or browsing for their product. To solve this problem the AMS 100 of an embodiment enables optimizers to propose ads to the advertiser 102 for use in the marketplace. The advertiser 102 can approve or reject these ads. The advertiser 102 can enforce that the ad must meet editorial and aesthetic guidelines as well as only direct the searching or browsing user to a certain set of decided upon landing pages.

Allowing optimizers to propose ads can be beneficial because the advertiser 102 gets the collective knowledge of all the optimizers working on their campaign. One optimizer 104 might propose an ad that the advertiser 102 would have never considered. Furthermore, when an optimizer 104 proposes an ad and it is accepted only that optimizer 104 is able to use the ad they proposed. This gives the proposing optimizer 104 an advantage in the marketplace as their earnings are based on their success. If a better written ad receives more clicks or a smarter ad sends the searcher or browser to a page that is specifically about the product they are looking for (as opposed to the homepage of the company who sells that product) the optimizer 104 is likely to make more money in the marketplace. Additionally, for companies that have large numbers of possible landing pages (e.g., companies that have large catalogs of products that might be advertised individually) the optimizer 104 is incentivized to do the work to create ads (and pick search terms and placements) for each specific entry in the catalog. While this work might be incredibly time consuming for the advertiser 102, it becomes manageable when spread across tens or even hundreds of optimizers in a campaign.

Regarding the components of the AMS 100 that include the choices of search terms and placements, ads, search engine and ad networks search term and placement auction prices, an optimizer 104 may search the market for campaigns they can work on when they enter into the market provided by the AMS 100. Once the optimizer 104 has joined a campaign they may start to submit their choices to the market, choices directed to how the optimizer 104 believes the advertiser 102 should approach selling their products. The optimizer 104 can make choices as to search terms, placements, search engines, ad networks, optimizer bid prices, and organization of stock and custom ads.

For search terms, the optimizer 104 can propose as many search terms to the market as they desire. Not all of the search tennis will be accepted due to terms of service and conflict resolution issues.

For placements, the optimizer 104 can propose as many placements to the market as they desire. Not all of the placements will be accepted due to terms of service and conflict resolution issues.

The optimizer 104 can also propose which search engines and ad networks (of the available ones specified by the advertiser 102 for the campaign) they desire to use for search terms and placements. For each search term on each search engine, the optimizer 104 can specify a bid price, and this bid price must be below the advertiser 102's bid price for the campaign. For each placement on each ad network the optimizer 104 can specify a bid price, and this bid price must be below the advertiser's bid price for the campaign.

The advertiser 102 may specify different bid prices for each ad network or class of advertising (e.g., paid search versus display versus mobile). The most specific constraint will apply to the optimizer 104 as a maximum bid for each search term or placement.

Optimizers can also organize stock and custom ads for the campaign into ad groups, and formulate associations between ads and search terms or placements. Through these actions or functions, the optimizer 104 can ensure the most relevant ad appears when a searcher types in one of their search terms or a user is browsing a placement.

Regarding the components of the AMS 100 that include the resolution of optimizer 104 suggestion conflicts, considering the AMS 100 in which multiple optimizers are suggesting search terms or placements for advertising campaigns, it is likely that more than one optimizer 104 will suggest the same term or placement. For example, in a campaign to sell cell phones, it is very logical that a few optimizers suggest “cell phones” as a search term. In a placement campaign it is logical two optimizers suggest “cnn.com” as a placement. Therefore, the AMS 100 of an embodiment includes numerous methods for resolving these conflicts. The market may expose one or more of these conflict resolution mechanisms to the advertiser 102 directly and let them choose which they want to use on their campaign.

A conflict resolution strategy or method of an embodiment is to have the market work in a first come, first served mode. In a campaign, if one optimizer 104 suggests a search term or placement and then another optimizer 104 suggests the same term or placement at a subsequent time, the second optimizer 104 is simply not allowed to use the search term or placement. The market would enforce various mechanisms to “return” a search term or placement to availability if the first optimizer 104 effectively did not use the term or placement. An example of this would be if an optimizer 104 did not bid enough money in the market to get a high enough position in the search engine auction or for the placement and ads for the advertiser 102 never appeared for those terms or on those placements. The market might decide to take the search term or placement back from the optimizer 104 if they did not raise their optimizer bid high enough to have the ad appear.

A conflict resolution strategy or method of an alternative embodiment is to consider the combination of ad, search term or placement, and search engine or ad network. As optimizers pick not only the search terms or placements and prices they want, they also pick the ads they want to associate with the search terms or placements as well as the search engine(s) or ad networks on which they want the ad(s) to appear. Under this method of conflict resolution, if an optimizer 104 has selected a search term or placement and then another optimizer 104 selects the same search term or placement, it can be granted to both optimizers if they have not selected the same triple or group of {ad, search term or placement, ad network}. An optimizer 104 that proposes ad copy is never denied the use of a search term or placement when used with that optimizer's proposed ads, as they are the only optimizer 104 that can use that ad.

For example, consider that optimizer A likes a stock ad from the advertiser 102 and they elect to put that ad onto Google with the search term “xyx”. Then optimizer B asks the market for the same ad and the same search term. If optimizer B requests that the market place this same combination of ad and search term on Google, the request will be disapproved because optimizer A “owns” that triple. If optimizer B requests the market place the ad and search term on Yahoo then they would be allowed to do so. If a third optimizer 104 came along and asked for the ad and search term on either Google or Yahoo they would be denied using it in both instances.

A conflict resolution strategy or method of another alternative embodiment allows the search engine or ad network to resolve conflicts for the market. The market will allow any optimizer 104 (up to all) to use the same search term or placement. All information will be submitted “as-is” to the ad network. Ad networks have sophisticated mechanisms for handling which combination of search term or placement, bid price, and ad is the most relevant to their searchers or browser. Thus, one strategy is for the market to defer to the judgment and results of the ad network. As the market can distinguish a click on the same search or placement that was suggested by one optimizer 104 versus another, the market can look at the resulting clicks and attribute them appropriately.

Regarding the components of the AMS 100 that include the enforcement of terms of service, when advertisers 102 create and place advertisements in any form (online, offline, print, etc.) they are always concerned about the content of their advertisement as well as the adjacency of their advertisement to other subjects. For example, one airline may not want advertisements for another airline to appear inside their in-flight magazines; this same situation is found in online advertising. Advertisers want control over their advertising. In addition, many places where one can advertise (online and offline) have specific rules about advertisement content and the types of products that can be advertised. If one advertises on television in the United States, the advertisement must conform to the FCC's standards for content and language. The same applies online and search engines and ad networks have terms of service by which the advertiser's 102 must abide (e.g., cannot promote tobacco products on Google).

The market both allows advertisers 102 to specify terms of service for their optimizers as well as enforce its own terms of service. Advertisers can specify what search terms and placements are off limits (e.g., brands, a website that contains nudity, etc.) as well as what advertising copy or aesthetic is unacceptable. They may also specify words not allowed to be used in or as search terms or in ad copy. For example, an advertiser 102 selling Halloween costumes may not want to show ads next to searches on a search engine with the words “free pattern” as part of the search term (as it is highly unlikely this searcher is looking to buy something).

Additionally, the market allows the advertiser 102 to specify the terms of service for their optimizers. The AMS 100 enforces these terms of service before ads or search terms or placements ever make it out to the search engine or ad network.

Regarding the components of the AMS 100 that include management of the search engine and ad network advertising campaign, the AMS 100 of an embodiment makes the appropriate changes on the search engines and ad networks that are running the final combined campaigns for the advertisers 102 every time an optimizer 104 submits changes or additions to a campaign. The market will first manage conflicts and enforce terms of service, and then directly updates the proxy advertiser campaigns on the search engine and ad network. The market may also query these accounts from time to time to get statistics and data relevant to analysis and payouts.

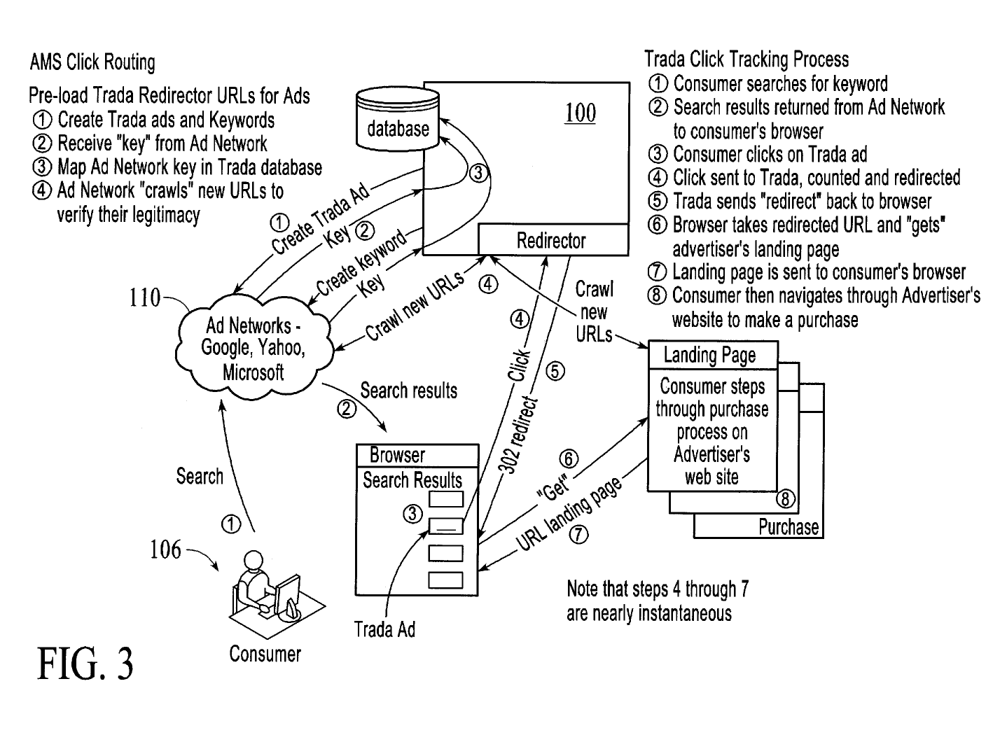

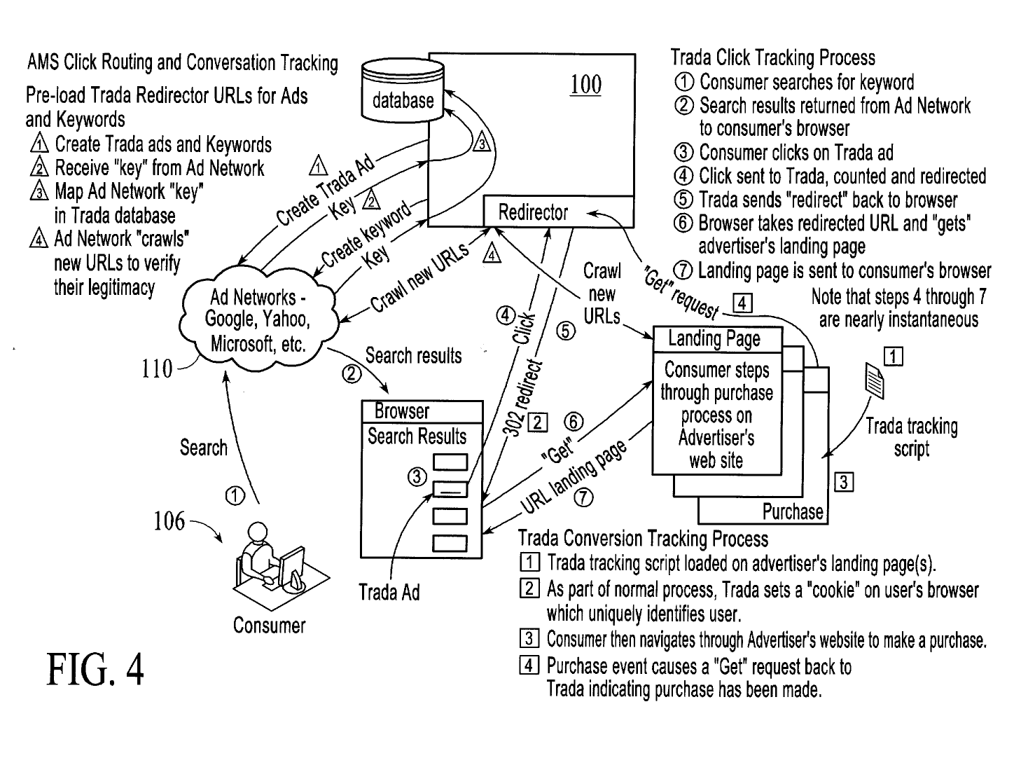

FIG. 3 is a block diagram of click routing using the AMS 100, under an embodiment. The final PPC or display campaign of an embodiment can be the result of the suggestions and ideas of numerous optimizers. As such, the AMS 100 includes a mechanism for attributing the results back to the original optimizer 104 who suggested them, and this mechanism routes clicks through the AMS 100 accounting system. When an ad is placed on the search engine or ad network to appear next to search results or on a specific location, it is done so with the landing page (usually a URL, e.g., http://www.microsoft.com) that the search engine or ad network should direct the searcher or browser to if they click on the ad. Generally, this is the homepage of the advertiser or a link directly to a specific product page in their catalog. When the market puts ads into the search engine or ad networks it replaces these landing page URLs with URLs on the AMS 100. When a user clicks on an ad on the search engine or ad network they are actually sent to a URL in the AMS 100. This URL is not visible to the user it simply records their visit and then directs them to the original advertiser landing page. The information recorded during the “redirect” is enough to discern which optimizer 104 was responsible for the suggestion and specifically on which search term, placement, campaign, ad network, and ad was clicked. From this information the spread, payout, etc. can be calculated. In addition, the click routing is used to identify the searcher or browser by placing a cookie in their browser for the marketplace. This cookie allows the market to track the user primarily to determine if the user purchased any item (e.g., causing a conversion). This conversion data is used for one or more of the Payout Mechanisms described below. FIG. 4 is a block diagram of click routing and conversion tracking using the AMS 100, under an embodiment.

Once clicks have been received in the redirector, the optimizer 104 may need to be paid out. The AMS 100 of an embodiment includes multiple payout mechanisms depending on how the advertiser's campaign is set up in the marketplace.

The AMS 100 of an embodiment includes a PPC spread payout model. This model calculates the spread by taking the advertiser's bid price and subtracting the optimizer's bid price for the search term that generated the click. For example, if the advertiser bids $0.60 cents in a PPC campaign in the market for all clicks and the optimizer 104 proposed a search term (and ad) at $0.40 to be placed on Google, and a searcher typed in that search term and then clicked on that ad, the spread would be $0.20 ($0.60−$0.40). If the optimizer 104 bid $0.30 on Yahoo and a click was received on Yahoo the spread would be $0.30 ($0.60−$0.30). The same applies to an optimizer 104 that proposed an ad placement on CNN for 0.40 and a browser clicked on the ad. Note that tiered bidding as described above applies here.

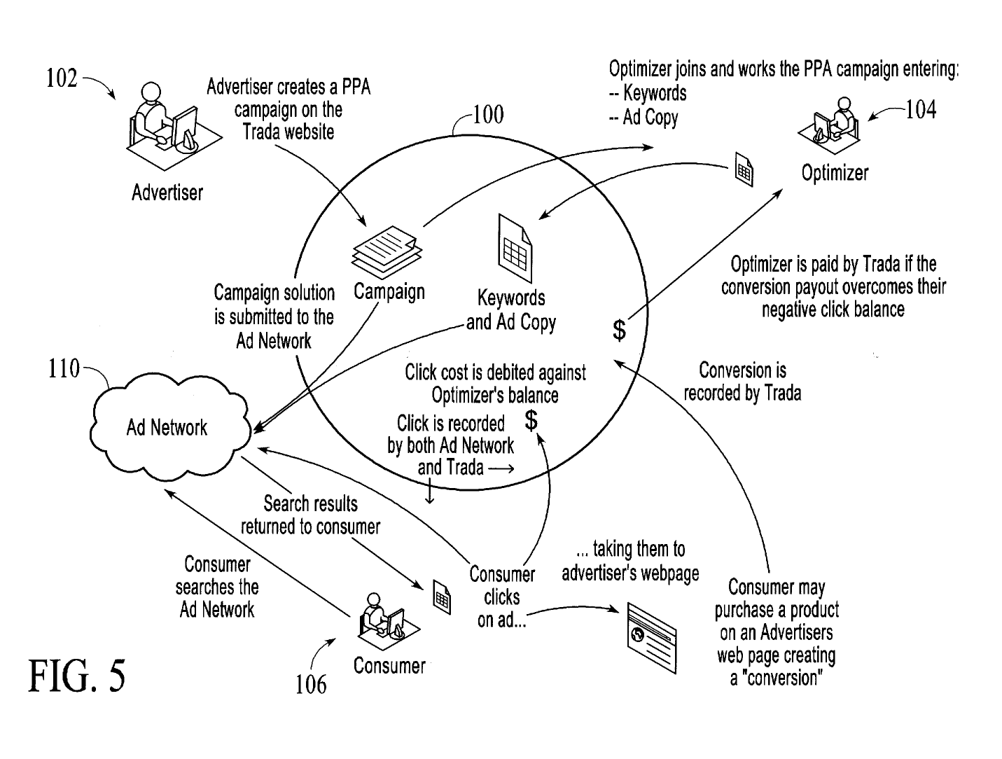

The AMS 100 of an embodiment includes a PPA spread payout model. FIG. 5 is a block diagram of PPA payouts using the AMS 100, under an embodiment. Many advertisers are focused on the cost of getting a conversion (e.g., a sale). To these advertisers, this is the ultimate metric which drives their success or failure. To accommodate this, the market uses the PPA mechanism. The PPA method allows the optimizers to still suggest search terms and placements, ads, search engine and ad networks, and optimizer bid prices but pays them not on every click generated, but only on a conversion.

When a PPA campaign is created, the advertiser must specify a PPA payout price. Assume an example where this is only one time of conversion, a sale. For each sale, the advertiser is willing to spend $10.00 in advertising to get the sale. This $10.00 is the PPA Payout. The advertiser creates the PPA campaign in the market and optimizers start to work on it. Imagine that an optimizer 104 puts in lots of suggestions of search terms and placements and ads for the campaign. The advertiser starts getting clicks through the market. Most of those clicks are users just browsing around, but not buying anything. And then finally one of those clicks turns into a sale. The advertiser has gotten a conversion. At that point in time the market would calculate the total advertiser's money spent before the conversion by the optimizer 104 that got the conversion and subtract it from the PPA Payout they specified. If the amount was positive (the optimizer 104 spent less of the advertiser's money than they were willing to pay), the optimizer 104 makes the difference. This is really the PPA spread. Note that the calculated amount might actually be less than 0 (the optimizer 104 spent more money than the advertiser was willing to pay), and in this scenario the optimizer 104 would not receive a payout. Conversion tiered pricing applies here.

There are a number of models of an embodiment used to calculate the difference between what an optimizer 104 is paid for a conversion and what the advertiser has offered as a payout. A description of these models follows.

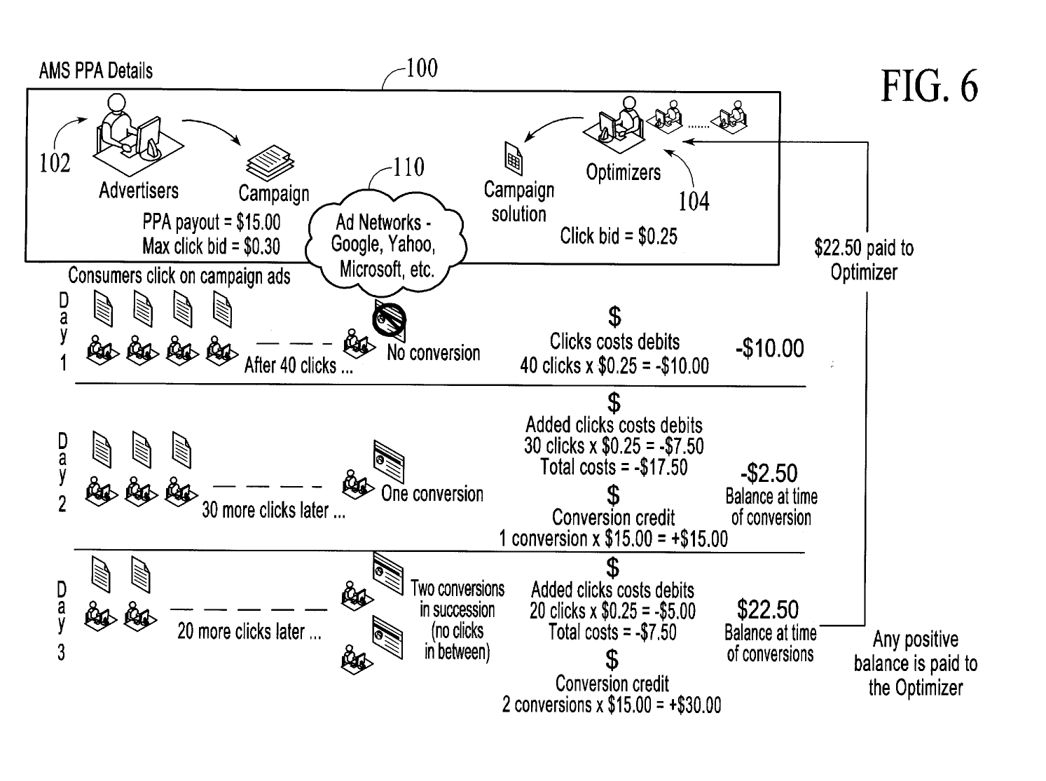

One model is to keep track of every click that an optimizer 104 has generated and a cost for those clicks. This is the “running balance” model. The “balance” is a running total of money spent versus “credits” from the PPA payouts. Conversions do not happen serially to clicks (e.g., someone clicks then buys in the next 2 minutes). A searcher or browser might click on an ad, look at the product, then return two weeks later and buy it, and this is a conversion. Because of how the market does click routing (above) it can track this. At the time the conversion is made, the PPA payout is credited to the optimizer's “balance”. Consider a situation where the optimizer 104 spends $25.00 of the advertiser's money in a $10.00 PPA payout scenario before a conversion is received. Assuming that three conversions happen two weeks later in quick succession, after the first conversion the optimizer's balance is −$15.00 (−$25.00+$10.00), and after the second conversion the optimizer's balance is −$5.00 (−$15.00+$10.00), and after the third conversion the optimizer's balance is +$5.00 (−$5.00+$10.00). The optimizer 104 would thus receive a payout for $5.00 and their “balance” would effectively be reset to $0. FIG. 6 shows another PPA example scenario using the AMS 100, under an embodiment.

Another model tracks the effective running costs per conversion of the optimizer 104 and pay out based on the difference between the current effective price (at the time of conversion) and the advertiser's conversion payout. For example, if an optimizer 104 spent $25 of the advertiser money in clicks from search terms and placements and had consummated five conversions, their current effective cost per conversion would be $5 per conversion. If another conversion came in immediately and the advertiser's payout was $10, the optimizer 104 would be paid $10−$5=$5 for that conversion, and their effective cost per conversion would immediately drop to $4.16 (e.g., $25/6=$4.16). Each new click without a conversion would then increase the effective cost per conversion again until the next conversion.

Either (or many) of these models can be tracked at the ad group level for each optimizer 104, or in totality across an advertiser's campaign for each optimizer 104. Changing the context of how each method is calculated can incentivize different activity (thinking more broadly about the whole campaign or in a more focused way about each specific strategy).

In addition to the paid search context described above, the optimizer 104 marketplace provided by the AMS 100 of an embodiment is applicable to most other forms of advertising, online and offline. Display advertising online is a massive industry spanning banner advertisements, sponsorships, interactive advertisements (embedded games or virtual worlds), video advertising, video game advertising (in game billboards and such), text ads on blogs, social networks, and other content sites, and much more. With the incredible amount of options both in content type (graphics versus text versus games) as well as content locations (which web sites should one advertise on or which videos should one advertise in) the complexity of doing efficient display advertising has emerged similarly to the paid search space. The AMS 100 of an embodiment, including the use of optimizers, a marketplace, and a pay for success model, provides a solution to this problem.

Consider an example of deciding which web sites are appropriate for display advertising. Currently the advertiser would go to a large advertising network (e.g., DoubleClick) and buy a certain number of impressions at a certain price, and the ad network would do their best to computationally decide which websites would be best to display the ads. In contrast, using the AMS 100 of an embodiment, an optimizer 104 can identify the websites relevant to the advertiser's products and submit to the market those websites along with the most relevant ads to the website readers and bid prices for those ads to compete with others that might be placed on the site. The advertiser would specify a bid price for those types of ads, the ads would be placed on those sites according to one or more optimizer's suggestions, and then the optimizer 104 would be paid the difference between the advertiser's bid price and the bid price they specified. If an ad was clicked on a site selected by the optimizer 104, only they would get the spread for that click (e.g., the optimizer 104 is now using the site location like they are using the keyword in the PPC/PPA campaigns).

A similar example could be made when considering in which videos (e.g., specific videos on YouTube or CBS.com) to place ads. Using the AMS 100, an optimizer 104 can identify a video they think is appropriate to an advertiser's product and through the AMS 100 suggest an advertisement to be shown in the identified video. The optimizer 104 can also select where in the video the ad would be placed (e.g., during a conversation about that type of product in the video). The advertiser would bid a rate for each impression, the AMS 100 would place ads in the suggested videos and the optimizer 104 would make the spread between the price of the ad placement and what the advertiser was willing to pay (augmented by some factor of how many impressions they got). The mechanisms described above for terms of service, conflict resolution, payout mechanisms, etc. apply to these types of online advertising and all performance-based advertising online where a specific unit such as a keyword or placement can be priced and tracked.

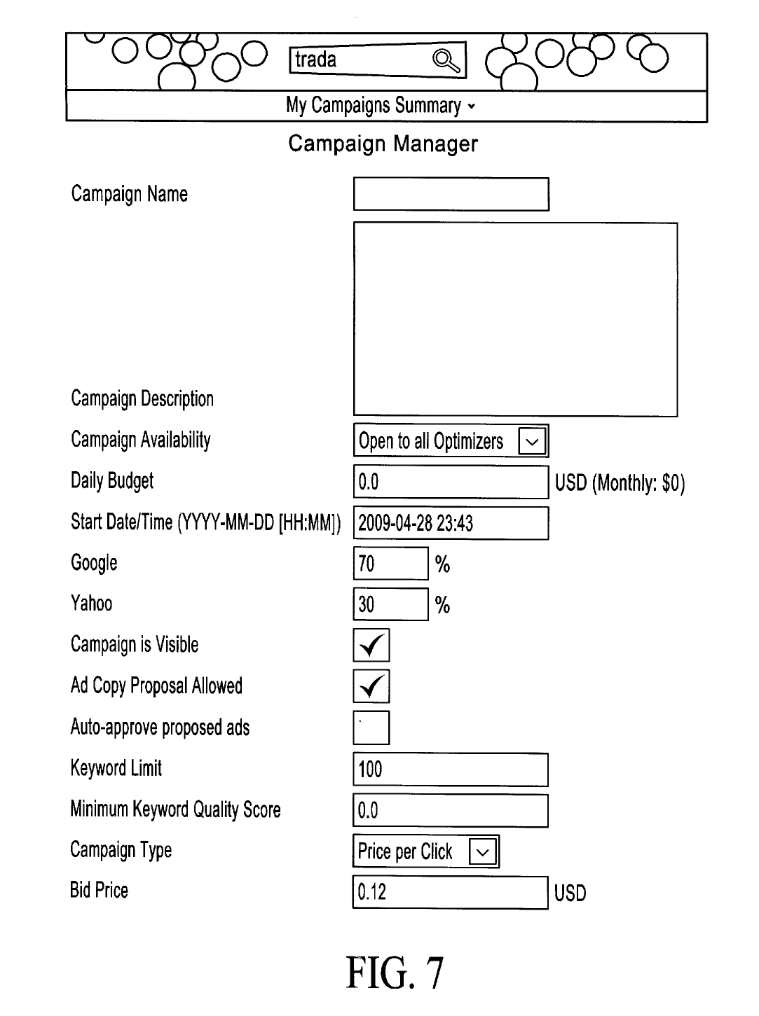

Following is a description of the AMS 100 of a specific embodiment. To create a campaign in the market using the AMS 100, the advertiser would log into the AMS 100 which provides an interface and feature set configured for the advertiser. One feature allows the advertiser to create a new campaign. Data of the campaign is stored in a database behind the application front end. The advertiser, using the AMS web interface, would supply one or more specific attributes of the campaign. More specifically, the advertiser can use a Campaign Manager interface to provide or input campaign attributes. FIG. 7 is an example Campaign Manager web page of the AMS 100, under an embodiment. Using the AMS web interface, the advertiser can specify one or more of the following attributes, but the embodiment is not so limited: type of campaign (which ad types and ad networks are allowed), approval type, bid price and tiers PPA payout and tiers, daily budget, ad networks spend and split, stock ads, Google Quality Score minimum, per optimizer keyword limit, allowing single keywords, bounce rate maximum, term of service (such as excluded keywords or placements) and ad proposal.

Regarding the campaign attributes, the type of campaign is one or more of the types PPC or PPA, as described above. Approval type is an exclusive denotation that the campaign is “Open”, “Approval”, or “Limited”, as described in detail above. Bid Price (PPC or PPA) is a monetary value specifying the upper limit to which an optimizer 104 can bid on keywords or the tiers of pricing that are allowed and their appropriate payouts. PPA payout (if PPA campaign) is a monetary value specifying the amount that an advertiser is willing to pay for a conversion or the tiers of these payouts and their percentage payout, as described above. Daily Budget is a monetary amount (e.g., whole dollars) specifying the maximum amount of money that can be spent in one day on advertising through the market. Ad Networks Spend is an exclusive denotation that the advertiser desires the split of their advertising spend between ad networks (e.g., Google AdWords, Yahoo Search Marketing, Microsoft AdCenter, DoubleClick, YouTube video ads) fixed to a specific percent (e.g., 60% on Google, 40% on Yahoo) or that they would like the market to dynamically allocate spend (never to exceed their daily budget). Stock Ads are ads that advertisers create for use by optimizers working on their campaign. Ad Proposal is an exclusive denotation if the optimizers are allowed to propose ads for use in the market on this campaign and if so, if the ads are automatically approved (allowed for use on ad networks) or must be approved by the advertiser prior to use.

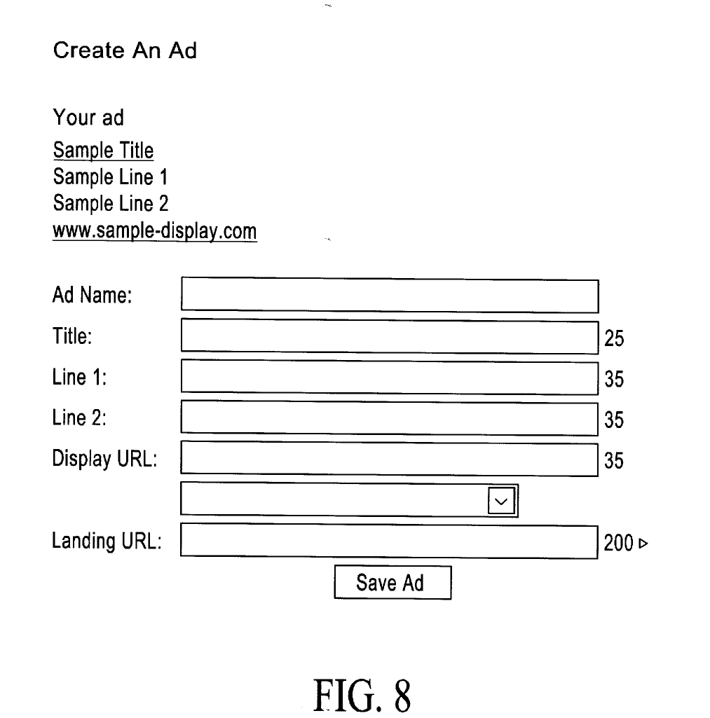

To create an advertisement using the AMS 100, the advertiser would log into the AMS 100 which provides an interface and feature set configured to create an ad. The advertiser, using the AMS web interface, supplies one or more specific attributes of the ad. More specifically, the advertiser can use a Create An Ad interface to provide or input ad attributes. FIG. 8 is an example Create An Ad web page of the AMS 100, under an embodiment. Using the AMS web interface, ads follow a specific format that is a common denominator format between the format requirements of each ad network that the market supports. Advertisers and optimizers enter information for their text ads through the web interface adhering to format constraints. For example, the title is limited to a maximum of 25 characters, the description line 1 is limited to a maximum of 35 characters, the description line 2 is limited to a maximum of 35 characters, the display uniform resource locator (URL) is a web URL without the leading protocol (e.g., http://) (e.g., mysite.com/demo, and the landing page URL is the actual web URL (including the leading protocol, http://www.mysite.com/marketing/demo/index.html). There is no limitation on the number of ads that can be created. Each ad will run on one or more ad networks as described in detail below.

Advertisers may also upload rich media advertisements if allowed for the ad networks their campaign will use. These rich media advertisements (e.g., graphics, interactive media, games, sounds, applications and videos) must conform to the requirements of the ad networks they will be deployed on and any AMS terms of service.

Advertiser may also select advertising templates from a third party marketplace provided by the AMS 100. They can insert their own advertising copy and messages into these advertisements through a template system and they may be required to purchase, rent, or share revenue with the third party provider in the marketplace (and potentially the AMS 100 as well) for the use of these templates. The mixture of the template and the ad copy shall be made available to an optimizer 104 as a stock ad.

Optimizers join the AMS marketplace by registering through a web application. After inputting information (e.g., name, email address, etc.) an optimizer 104 can join and work on campaigns. As for joining a campaign, optimizers can see a list of available advertising campaigns to work on along with associated statistics of the campaign. These statistics can include, but are not limited to, the number of optimizers already working on the campaign, the total keywords in the campaign, the ad networks on which the campaign is running, the stock ads available in the campaign, and the campaign type. Only campaigns available for the optimizer 104 to join are visible to them (some campaigns are run as “Limited” which means they are available to join only for specific optimizers). Joining a campaign means the optimizer 104 selects, through the web interface, to join a campaign. Optimizers may or may not have a limitation on the number of campaigns they can join based on their current performance, how new they are, or which AMS-defined goals they have achieved. Some campaigns will be listed as Approval-based and the optimizer 104 must effectively apply to the campaign. Based on the advertiser's analysis of their history and statistics on other campaigns the optimizer 104 may or may not be allowed to join that campaign.

Once the optimizer 104 has joined a campaign they can start to build their suggestions for the campaign. This is done all through the AMS 100 website, the optimizers never work directly with the ad networks. Optimizers have numerous choices to make to effectively start contributing to the campaign.

The optimizer 104 can start contributing to a campaign by creating an ad group. An ad group is a combination of ads (stock or proposed) and associate keywords (and their bid prices) or placements. The optimizer 104 creates an ad group by naming it and then selecting one or more available ads to put into that ad group. Ads are selected from the web interface which shows all ads available to the optimizer 104 in a format that resembles how they would look on the ad network. Ads may either be stock ads created by the advertiser or any approved proposed ads from the optimizer 104 (if ad proposal is allowed for the current campaign). Ads can be used in more than one ad group, an ad group must have a minimum of one ad in it to be active, and there are no limits on the number of ad groups that can be created by an optimizer 104 for each campaign outside of the constraints put on the AMS 100 by the ad networks.

The optimizer 104 can propose as many search terms (keywords) or placements as they like for an ad group. Search terms or placements should adhere to the format requirements of the ad networks as well as follow the terms of service and rules of the ad network. For example, profanity can not be used. A keyword (or keyword phrase) or placement may be used only once in an ad group and capitalization and order for multiple words does not matter (e.g., DOG and dog are equivalent, and “free admission” and “admission free” are equivalent. Not all proposed search terms or placements will be accepted due to terms of service and conflict resolution issues described herein.

When the optimizer 104 proposes search terms or placements, they also specify on which ad networks (of the available ones specified by the advertiser for the campaign) they want to place their ads and corresponding search terms or placements. This is done through the web interface by entering information in the ad network specific fields.

For each search term or placement suggested, and for each ad network the optimizer 104 selects, the optimizer 104 must specify a price (bid price) that they want the market to bid to the ad network for that search term. This bid price should be below the advertiser's bid price for the campaign, and in a tiered bid situation, it must be below the highest tier available to the optimizer 104. There are various rules about valid bid prices such as minimums (some ad networks require a minimum bid price such at 0.05 cents) or maximums (bids cannot be higher than the advertiser's campaign bid price).

Optimizers can also create negative keywords, which are words that, if typed into an ad network by a searcher, do not cause their ads to be displayed. For example, if the optimizer 104 has entered the search term “Halloween costumes” they might choose to enter “patterns” as a negative keyword so that their ads do not appear next to search terms for “halloween costume patterns” (as they don't want to spend ad dollars on search engine users looking for free costume patterns to make themselves as opposed to buying a costume online).

Optimizers can also create exclusionary placements, which are placements on which the ad network is not allowed to show their ad. For example, if the optimizer 104 has entered the placement “http://www.cnn.com” and the exclusionary placement “http://www.cnn.com/health/,” the ad network should not show their ads on anything under the “health” section of CNNs website. They may however show it in the “Tech” section or “Sports” section. Different ad networks have different mechanisms for allowing exclusionary placements but they usually are similar in format to positive placements.

In a system where multiple optimizers are suggesting search terms or placements for the same advertising campaign, it is likely that at some point more than one optimizer 104 will suggest the same term or placement. For example, in a campaign to sell cell phones, it is very logical that a few optimizers suggest “cell phones” as a search term. The AMS market has a number of mechanisms for resolving these conflicts, as described above. Conflict resolution is done at the time of search term entry so that an optimizer 104 is warned if a search term or placement is not available to them. If a search term or placement is not available the web interface alerts the optimizer 104 that this is the case and that search term or placement will not be granted to the optimizer 104 for use.

Advertisers may create terms of service (TOS) for their campaigns. These terms specifically prevent the use of search terms or placements by the optimizer 104 in their campaign. These TOS search terms fall into four broad categories: blacklisted keywords and placements, browlisted keywords and placements, whitelisted keywords and placements and ad copy guidelines. In all four cases, the advertiser enters into the web interface the search terms or placements they want prevented from use by optimizers on the campaign. These search terms and placements apply to all ad networks in use on the campaign. There is no limitation to what these terms or placements might be (profanity is allowed in these terms) and no limitation on the number of terms or placements.

Advertisers may also specify ad copy guidelines through the interface. These guidelines are written restrictions on what is allowed when proposing ads. These restrictions might describe allowable ad copy, excluded phrases or brand terms, and the types of aesthetics that are allowed, for example.

Search terms with the same words but in different order, or terms that are the same but have varying capitalization, are considered the same term.

When an optimizer 104 proposes a search term or placement for a campaign, the optimizer's search term or placement is matched against all TOS search terms. If there is a match, the optimizer 104 is alerted of the match and the search term or placement is not allowed for the optimizer 104 on this campaign.

Advertisers may also list TOS keywords as derivatives which will prevent a multi-word keyword phrase from containing any derivative keyword in it. For example, if the advertiser has derivative blacklisted the word “free” the optimizer 104 may not use the keyword phrase “free event tickets” as it contains the word “free”.

Advertisers may also list TOS placements as derivative which will prevent any placement on a URL or application that is more specific than what is specified. For example, a derivative domain could be http://nudity.com, and this domain excludes any placement on any URL or sub-domain of that URL. In the context of video placements, an advertiser may specify disallowed “tags”. Any video that is tagged with one of the disallowed tags (e.g., “nude”, “hate”, etc.) would be excluded from being a viable placement.

Blacklisted keywords and placements are keywords and placements the advertiser wants the optimizers to see that are not allowed. Brownlisted keywords and placements are keywords and placements the advertiser does not want to show to the optimizers as they may be vulgar or known keywords or placements that do not produce any sales. Whitelisted keywords and placements are keywords and placements the advertiser is running in a parallel advertising campaign that they want to prevent the optimizers from using and thus bidding against them on.

Advertisers can also specify negative keywords or exclusionary placements for their campaign. Advertiser negative keywords and exclusionary placements work the same way that optimizer negative keywords and exclusionary placements work but are in effect for every ad group all optimizer's create. Optimizers can see these negative keywords and exclusionary placements. Advertisers enter these negative keywords and exclusionary placements in the web interface. These search terms and placements apply to all ad networks in use on the campaign. There is no limitation to what these terms might be and no limitation on the number of terms. Terms with the same words but in different order, or terms that are the same but have varying capitalization, are considered the same term. Placements in different formats that have the same canonical format are considered the same term (e.g., http://www.cnn.com/ and cnn.com may be the same thing in terms of a placement). Negative keywords and exclusionary placements prevent the ad networks from showing an advertiser's ad (from any optimizer 104) if that keyword appears in the search phrase or the placement is available on the network. For example, an advertiser might use a negative of “pictures” which prevents their ads from being shown if someone searched for “pictures of designer clothes” on an ad network. They would do this because they have learned that users looking for pictures are unlikely to buy something from their site compared, for example, to a user looking for “designer clothing discounts”.

The marketplace web site is a front end to the actual ad network functionality for doing paid search or working on performance based advertising campaigns. An advertiser and an optimizer 104 work through the marketplace interface and never directly interact with the ad network accounts/interface themselves.

The marketplace creates a separate ad network account on each ad network for each campaign for each advertiser. The market may create more than one account on each ad network for each advertiser (e.g., the market may create one account for each optimizer 104 on each advertiser campaign). When the advertiser creates a campaign one or more accounts are created automatically for them by the market. The specific ad network account (e.g., a Google AdWords Account) is coupled with the marketplace campaign for that advertiser.

Advertisers have a number of campaign settings available for selection through the AMS marketplace. Some of these settings are directly applicable to ad network account campaign settings. In that event, the AMS market matches the settings from the market campaign to the ad network campaigns (where applicable) for all ad networks on which the campaign is running.

When optimizers work on a campaign, their information is put into the ad network accounts for the market campaign they are working on at the ad group level. When an optimizer 104 creates an ad group (a collection of ads running together) in the market an ad group is created on the application ad networks inside the applicable network campaign.

When optimizers do work on the campaign, there are various types of changes that are made to the ad network accounts. All changes to ad network campaigns can be made through the ad networks programmatic APIs (e.g., the Google AdWords API) or manually by any authorized user. The changes of an embodiment include, but are not limited to, changing ads, changing keywords, changing placements, changing bid prices, pausing a campaign, pausing keywords, pausing placements, and budget management.

When an optimizer 104 changes the ads (e.g., adds them, edits them, removes them, etc.) in an ad group, ads are either created, deleted, or changed (edits made) in the ad network campaign ad groups corresponding to the changes. An optimizer 104 can change (add or remove) keywords and placements in an ad group. When these changes are made in the market, the appropriate changes are made in the ad network campaign ad groups matching the optimizer ad groups in the market.

An optimizer 104 can change bid prices in an ad group (within the limits specified by the advertiser on the campaign). When keyword or placement bid prices are changed, the appropriate bid prices in the ad network ad group are changed in response. Optimizers can have different bid prices for the same keyword or placement on different ad networks (e.g., a bid of 60 cents on Google and 40 cents on Yahoo).

When an advertiser pauses a campaign in the marketplace, all ad network campaigns related to that market campaign are paused immediately on the ad networks. While this does not guarantee no future clicks will occur (as there is some time lag), in general this allows the advertiser to shut down all ad network campaigns near instantly. When an optimizer 104 pauses a keyword or placement in an ad group or a complete ad group, the corresponding keyword or placement or ad group is paused in all ad network campaigns in which the corresponding ad group and keyword or placement is running.

Regarding budget management, advertisers in the market can specify their cross-ad network budget (on a daily and monthly basis). They can also specify the split of their budget to go to each of the ad networks. The market monitors the incoming clicks (and thus the ad network spends) and keeps track of the total daily budget and per-ad network daily budgets. Once the total daily budget or per-ad network daily budget approaches being met, the market will automatically pause campaigns on one or all of the ad networks to prevent spending of more than the daily budget.

The AMS 100 of an embodiment provides a final PPC or display campaign that is the result of the collaboration and ideas of numerous optimizers. In so doing, the AMS 100 includes a mechanism for attributing the results back to the original optimizer 104 who suggested the results, and the mechanism includes routing clicks through the AMS accounting system.

As described above, FIG. 4 is a block diagram of click routing and conversion tracking using the AMS 100, under an embodiment. When an ad is placed on the search engine to appear next to search results or on a placement, it is done so with the landing page (usually a URL (e.g., http://www.microsoft.com) to which the search engine or ad network should direct the searcher or browser in response to a click on the ad. This can be the homepage of the advertiser, a link directly to a specific product page in their catalog, or a link to any other web page or web site. When the AMS 100 puts ads into ad network campaigns it replaces these landing page URLs with URLs on the AMS 100. When a user clicks on an ad on the search engine or ad network they are sent to a URL hosted by the AMS 100. This URL is not visible to the user as it simply records their visit and then redirects them to the original advertiser landing page. Therefore, the inbound information from the ad network (ad that was clicked, keyword that was typed, etc.) can be correlated directly back to one specific optimizer 104 in the system working on that campaign. From this information the spread, payout, etc. is calculated.

In addition, click routing is used to track the searcher by placing a cookie in their browser for the marketplace. This occurs when the user clicks on an ad network ad and is directed through the AMS 100 server before being redirected to the advertiser web site. During this redirection, the AMS 100 places in the user's browser and this cookie allows the market to track the user primarily to determine if the user has a conversion (e.g., buying something, registering, signing up for a demonstration, etc.) on the advertiser's website. Detection of a conversion is accomplished by including a conversion tracking code (an image or a javascript reference that requests a URL from the AMS 100) which allows the AMS 100 to query the user's cookie and determine if they went to the advertiser's website as a result of the AMS 100. This is referred to as conversion tracking and the AMS 100 implements conversion tracking so that advertisers need only one conversion tracking solution across multiple ad networks. The AMS 100 may use individual conversion tracking mechanisms from each ad network as well to verify conversion data collected by the market. If not for the conversion tracking provided by the AMS 100, the advertiser would be required to place a conversion tracking code into the website pages for each ad network on which their campaign runs (e.g., a “Thanks for buying!” page). In some types of campaigns in the market (e.g., a PPA campaign) it is this conversion data that is required for one or more of the Payout Mechanisms.

Once clicks have been received in the redirector, the appropriate spread can be calculated for the optimizer 104 payment. Payments are put into a pending state for up to two weeks while various fraud analytics are run (e.g., click fraud, conversion fraud, etc.), and so the advertiser has a waiting period in which to contest invalid conversions (or returns of products). Once optimizers have met a certain minimum of earned money, they can be paid using a variety of means such as check, PayPal or ACH, to name a few.

Optimizers and advertisers need consistent feedback about the performance of their ad groups, keywords, placements, pricing strategies, budgets, and ad network allocations, to name a few. This data is all available from the ad networks via the programmatic APIs of the AMS 100. The AMS 100 periodically queries the latest data of each ad network campaign and copies that data into its own database. This data is then presented the optimizers and advertisers for use in making decisions about what changes to make on the campaign. The AMS 100 may collect and present data including but not limited to, campaign performance, budget spend, conversions, keyword statistics (impressions, clicks, conversions), placement statistics (impressions, clicks, conversions) and ad performance.

Embodiments described herein include a method executing on a processor. The method comprises receiving a plurality of campaign attributes from an advertiser. The plurality of campaign attributes comprise types of advertising permitted by the advertiser and a budget limit per type of advertising. The method comprises generating from the plurality of campaign attributes an advertising campaign on at least one advertising network that includes online advertising networks. The method comprises receiving a plurality of optimizer solutions from a plurality of optimizers. The plurality of optimizer solutions correspond to the advertising campaign. An optimizer solution comprises at least one parameter of the advertising campaign. The at least one parameter includes a budget allocation between each of the types of advertising permitted by the advertiser. The method comprises generating an optimized advertising campaign by updating the advertising campaign on the at least one advertising network using the plurality of optimizer solutions. The optimized advertising campaign comprises optimized advertisements resulting from the plurality of optimizer solutions.

Embodiments described herein include a method executing on a processor, the method comprising: receiving a plurality of campaign attributes from an advertiser, wherein the plurality of campaign attributes comprise types of advertising permitted by the advertiser and a budget limit per type of advertising; generating from the plurality of campaign attributes an advertising campaign on at least one advertising network that includes online advertising networks; receiving a plurality of optimizer solutions from a plurality of optimizers, wherein the plurality of optimizer solutions correspond to the advertising campaign, wherein an optimizer solution comprises at least one parameter of the advertising campaign, wherein the at least one parameter includes a budget allocation between each of the types of advertising permitted by the advertiser; and generating an optimized advertising campaign by updating the advertising campaign on the at least one advertising network using the plurality of optimizer solutions, wherein the optimized advertising campaign comprises optimized advertisements resulting from the plurality of optimizer solutions.

The campaign attributes of an embodiment comprise an optimizer payment system of the advertising campaign.

The optimizer payment system of an embodiment comprises a Pay Per Click (PPC) model, wherein the campaign attributes comprise a click bid price.

The optimizer payment system of an embodiment comprises a Pay Per Action (PPA) model, wherein the campaign attributes comprise a conversion bid price.

The optimizer payment system of an embodiment comprises paying optimizers based on a characteristic of a visitor to the advertising campaign, wherein the campaign attributes comprise a target value for at least one variable that represents the viewer, wherein the at least one variable is one or more of bounce rate, time on site, percentage of new visitors.

The campaign attributes of an embodiment comprise campaign budget.

The campaign attributes of an embodiment comprise at least one advertisement for use by the plurality of optimizers.

The campaign attributes of an embodiment comprise the at least one advertising network, wherein the at least one advertising network includes at least one online search engine.

The campaign attributes of an embodiment comprise the at least one advertising network and a budget allocation per network, wherein the at least one advertising network includes at least one online search engine.

The campaign attributes of an embodiment comprise advertisement guidelines to be followed when the plurality of optimizers generates advertisement content.

The at least one parameter of an embodiment is advertisement content.

The at least one parameter of an embodiment is advertisement placement on an advertising network, wherein the advertising network includes an online search engine.

The at least one parameter of an embodiment is a search term to be associated with an advertisement.

The at least one parameter of an embodiment is a bid price.

The at least one parameter of an embodiment comprises two or more of advertisement content, advertisement placement on an advertising network including an online search engine, a search term to be associated with an advertisement, and a bid price.

The at least one parameter comprises a set of parameters that includes advertisement content, advertisement placement on an advertising network including an online search engine, and a search term to be associated with an advertisement.

The at least one parameter comprises an organization scheme for an advertisement group including a plurality of advertisements.

The at least one parameter comprises an association between an advertisement and a search term.

The method of an embodiment comprises automatically resolving a conflict between the plurality of optimizer solutions.

The method of an embodiment comprises automatically attributing results of the advertising campaign selectively to the plurality of optimizers, wherein the attributing results of the advertising campaign to the plurality of optimizers comprises receiving data of a selected advertisement that is an advertisement selected for viewing via a remote user interface, determining a sourcing optimizer that is the optimizer that submitted the optimizer solution corresponding to the selected advertisement, and generating credit to the sourcing optimizer as a result of the selected advertisement.

The method of an embodiment comprises directing the user interface to an advertising management system (AMS) platform in response to the selected advertisement being selected for viewing, recording the data of the selected advertisement at the AMS platform, and redirecting the user interface to a website landing page that corresponds to the selected advertisement, comprising placing a cookie at the user interface for performing conversion tracking, wherein the conversion tracking comprises collecting via the cookie conversion data of a conversion executed with the user interface.

The method of an embodiment comprises presenting a user interface to the plurality of optimizers, wherein the user interface is coupled to an advertising management system (AMS) platform, wherein an optimizer generates the optimizer solution at the AMS platform via the user interface.

The optimizer solution of an embodiment comprises generating an advertisement group that is an optimizer solution, the advertisement group including an advertisement and at least one of a search term and an advertisement placement on the at least one advertising network.

Generating the optimizer solution of an embodiment comprises at least one of selecting an advertisement from an advertisement database of the AMS platform and generating an advertisement by adding content to the AMS platform.

Generating the optimizer solution of an embodiment comprises specifying a bid price for the at least one parameter of the optimizer solution.

The method of an embodiment comprises automatically tracking performance data of the advertising campaign, wherein the performance includes at least one of campaign performance, ad performance, budget spending, conversions, search term impressions, search term clicks, search term conversions, placement impressions, placement clicks, and placement conversions, and presenting to the plurality of optimizers via a user interface the performance data.

Embodiments described herein include an advertising system comprising an advertising management system (AMS) platform. The system of an embodiment comprises a plurality of campaign attributes. The plurality of campaign attributes are received at the AMS platform from an advertiser via a user interface. The plurality of campaign attributes comprise types of advertising permitted by the advertiser and a budget limit per type of advertising. The system of an embodiment comprises an advertising campaign generated by the AMS platform from the plurality of campaign attributes and hosted on at least one advertising network. The system of an embodiment comprises a plurality of optimizer solutions comprising at least one parameter of the advertising campaign received at the AMS platform from a plurality of optimizers. An optimizer solution comprises at least one parameter of the advertising campaign. The at least one parameter includes a budget allocation between each of the types of advertising permitted by the advertiser. The AMS platform generates an optimized advertising campaign by updating the advertising campaign on the at least one advertising network using the plurality of optimizer solutions. The optimized advertising campaign comprises optimized advertisements resulting from the plurality of optimizer solutions.

Embodiments described herein include an advertising system comprising: an advertising management system (AMS) platform; a plurality of campaign attributes, wherein the plurality of campaign attributes are received at the AMS platform from an advertiser via a user interface, wherein the plurality of campaign attributes comprise types of advertising permitted by the advertiser and a budget limit per type of advertising; an advertising campaign generated by the AMS platform from the plurality of campaign attributes and hosted on at least one advertising network; a plurality of optimizer solutions comprising at least one parameter of the advertising campaign received at the AMS platform from a plurality of optimizers, wherein an optimizer solution comprises at least one parameter of the advertising campaign, wherein the at least one parameter includes a budget allocation between each of the types of advertising permitted by the advertiser; and wherein the AMS platform generates an optimized advertising campaign by updating the advertising campaign on the at least one advertising network using the plurality of optimizer solutions, wherein the optimized advertising campaign comprises optimized advertisements resulting from the plurality of optimizer solutions.

The AMS platform of an embodiment selectively attributes results of the advertising campaign to the plurality of optimizers by receiving data of a selected advertisement that is an advertisement selected for viewing via the user interface, determining a sourcing optimizer that is the optimizer that submitted the optimizer solution corresponding to the selected advertisement, and generating credit to the sourcing optimizer as a result of the selected advertisement.

The advertising system of an embodiment comprises directing the user interface to the AMS platform in response to the selected advertisement being selected for viewing and recording the data of the selected advertisement at the AMS platform, and redirecting the user interface to a website landing page that corresponds to the selected advertisement, wherein the AMS platform places a cookie at the user interface, wherein the cookie performs conversion tracking that comprises collecting conversion data of a conversion executed through the user interface.

The user interface of an embodiment is used to generate the optimizer solution.

The advertising system of an embodiment comprises generating the optimizer solution by selecting an advertisement from an advertisement database of the AMS platform.

The advertising system of an embodiment comprises generating the optimizer solution by generating an advertisement by adding content to the AMS platform.

The advertising system of an embodiment comprises generating the optimizer solution by specifying a bid price for the at least one parameter of the optimizer solution.

The user interface of an embodiment is used to generate changes to the optimizer solution, wherein the AMS platform propagates the changes to the advertising campaign, wherein the changes include at least one change made to the at least one parameter, wherein the at least one change is at least one of an edit, an addition, and a deletion.

The AMS platform of an embodiment automatically tracks performance data of the advertising campaign and presents the performance data to the plurality of optimizers via the user interface, wherein the performance includes at least one of campaign performance, ad performance, budget spending, conversions, search term impressions, search term clicks, search term conversions, placement impressions, placement clicks, and placement conversions.

The campaign attributes of an embodiment comprise an optimizer payment system of the advertising campaign.

The optimizer payment system of an embodiment comprises a Pay Per Click (PPC) model, wherein the campaign attributes comprise a click bid price.

The optimizer payment system of an embodiment comprises a Pay Per Action (PPA) model, wherein the campaign attributes comprise a conversion bid price.

The optimizer payment system of an embodiment comprises paying optimizers based on a characteristic of a visitor to the advertising campaign.

The campaign attributes of an embodiment comprise campaign budget.

The campaign attributes of an embodiment comprise at least one advertisement for use by the plurality of optimizers.

The campaign attributes of an embodiment comprise the at least one advertising network, wherein the at least one advertising network includes at least one online search engine.

The campaign attributes of an embodiment comprise the at least one advertising network and a budget allocation per network, wherein the at least one advertising network includes at least one online search engine.

The campaign attributes of an embodiment comprise advertisement guidelines to be followed when the plurality of optimizers generates advertisement content.

The at least one parameter of an embodiment is advertisement content.

The at least one parameter of an embodiment is advertisement placement on an advertising network, wherein the advertising network includes an online search engine.

The at least one parameter of an embodiment is a search term to be associated with an advertisement.

The at least one parameter of an embodiment is a bid price.

The at least one parameter of an embodiment comprises an organization scheme for an advertisement group including a plurality of advertisements.

Embodiments described herein include a method executing on a processor, the method comprising receiving a plurality of campaign attributes from an advertiser via a user interface. The method of an embodiment comprises generating from the plurality of campaign attributes an advertising campaign on at least one advertising network that includes online advertising networks. The method of an embodiment comprises receiving a plurality of optimizer solutions from a plurality of optimizers. The plurality of optimizer solutions of an embodiment correspond to the advertising campaign. An optimizer solution of an embodiment comprises at least one parameter of the advertising campaign. The method of an embodiment comprises generating an optimized advertising campaign by updating the advertising campaign on the at least one advertising network using the plurality of optimizer solutions. The optimized advertising campaign of an embodiment comprises optimized advertisements and advertising campaign budget resulting from the plurality of optimizer solutions.

Embodiments described herein include a method executing on a processor, the method comprising: receiving a plurality of campaign attributes from an advertiser via a user interface; generating from the plurality of campaign attributes an advertising campaign on at least one advertising network that includes online advertising networks; receiving a plurality of optimizer solutions from a plurality of optimizers, wherein the plurality of optimizer solutions correspond to the advertising campaign, wherein an optimizer solution comprises at least one parameter of the advertising campaign; and generating an optimized advertising campaign by updating the advertising campaign on the at least one advertising network using the plurality of optimizer solutions, wherein the optimized advertising campaign comprises optimized advertisements and advertising campaign budget resulting from the plurality of optimizer solutions.

The campaign attributes of an embodiment comprise an optimizer payment system of the advertising campaign.

The optimizer payment system of an embodiment comprises a Pay Per Click (PPC) model.

The campaign attributes of an embodiment comprise a click bid price.

The optimizer payment system of an embodiment comprises a Pay Per Action (PPA) model.

The campaign attributes of an embodiment comprise a conversion bid price.

The optimizer payment system of an embodiment comprises paying optimizers based on a characteristic of a visitor to the advertising campaign.

The campaign attributes of an embodiment comprise a target value for at least one variable that represents the viewer, wherein the at least one variable is one or more of bounce rate, time on site, percentage of new visitors.

The campaign attributes of an embodiment comprise campaign budget.

The campaign attributes of an embodiment comprise at least one advertisement for use by the plurality of optimizers.

The campaign attributes of an embodiment comprise the at least one advertising network, wherein the at least one advertising network includes at least one online search engine.

The campaign attributes of an embodiment comprise the at least one advertising network and a budget allocation per network, wherein the at least one advertising network includes at least one online search engine.

The campaign attributes of an embodiment comprise advertisement guidelines to be followed when the plurality of optimizers generates advertisement content.

The campaign attributes of an embodiment comprise terms of service.

The at least one parameter of an embodiment is advertisement content.

The at least one parameter of an embodiment is advertisement placement on an advertising network, wherein the advertising network includes an online search engine.

The at least one parameter of an embodiment is a search term to be associated with an advertisement.

The at least one parameter of an embodiment is a bid price.

The at least one parameter of an embodiment comprises two or more of advertisement content, advertisement placement on an advertising network including an online search engine, a search term to be associated with an advertisement, and a bid price.

The at least one parameter of an embodiment comprises a set of parameters that includes advertisement content, advertisement placement on an advertising network including an online search engine, and a search term to be associated with an advertisement.

The at least one parameter comprises an organization scheme for an advertisement group including a plurality of advertisements.

The at least one parameter comprises an association between an advertisement and a search term.

The method of an embodiment comprises automatically resolving a conflict between the plurality of optimizer solutions.

The resolving of the conflict comprises using a first optimizer solution when a first optimizer solution and a second optimizer solution are received and the second optimizer solution is the same as the first optimizer solution.

The method of an embodiment comprises returning the first optimizer solution to a status of available for use by the plurality of optimizers when it ceases to be used by a first optimizer.

The resolving of the conflict comprises allowing use of the plurality of optimizer solutions by more than one optimizer, wherein each of the plurality of optimizer solutions comprises a plurality of parameters and at least one parameter is the same between the plurality of optimizer solutions and at least one parameter is different between the plurality of optimizer solutions.

The method of an embodiment comprises automatically attributing results of the advertising campaign selectively to the plurality of optimizers.

Attributing results of the advertising campaign to the plurality of optimizers comprises: receiving data of a selected advertisement that is an advertisement selected for viewing via a remote user interface; determining a sourcing optimizer that is the optimizer that submitted the optimizer solution corresponding to the selected advertisement; and generating credit to the sourcing optimizer as a result of the selected advertisement.

The method of an embodiment comprises directing the user interface to an advertising management system (AMS) platform in response to the selected advertisement being selected for viewing. The method of an embodiment comprises recording the data of the selected advertisement at the AMS platform.

The method of an embodiment comprises, subsequent to the recording, redirecting the user interface to a website landing page that corresponds to the selected advertisement.

The method of an embodiment comprises placing a cookie at the user interface for performing conversion tracking, wherein the conversion tracking comprises collecting via the cookie conversion data of a conversion executed with the user interface.

The method of an embodiment comprises simultaneously running a plurality of advertising campaigns, wherein the plurality of advertising campaigns comprises the advertising campaign. The method of an embodiment comprises presenting to the plurality of optimizers via a user interface the plurality of advertising campaigns and campaign statistics corresponding to each of the plurality of advertising campaigns.

The method of an embodiment comprises presenting a user interface to the plurality of optimizers, wherein the user interface is coupled to an advertising management system (AMS) platform, wherein an optimizer generates the optimizer solution at the AMS platform via the user interface.

Generating the optimizer solution of an embodiment comprises generating an advertisement group that is an optimizer solution, the advertisement group including an advertisement and at least one of a search term and an advertisement placement on the at least one advertising network.

Generating the optimizer solution of an embodiment comprises selecting an advertisement from an advertisement database of the AMS platform.

Generating the optimizer solution of an embodiment comprises generating an advertisement by adding content to the AMS platform.

Generating the optimizer solution of an embodiment comprises specifying a bid price for the at least one parameter of the optimizer solution.

The method of an embodiment comprises generating changes to the optimizer solution via the user interface, and propagating the changes to the advertising campaign.

The changes of an embodiment include at least one change made to the at least one parameter, wherein the at least one change is at least one of an edit, an addition, and a deletion.

The method of an embodiment comprises automatically tracking performance data of the advertising campaign, wherein the performance includes at least one of campaign performance, ad performance, budget spending, conversions, search term impressions, search term clicks, search term conversions, placement impressions, placement clicks, and placement conversions. The method of an embodiment comprises presenting to the plurality of optimizers via a user interface the performance data.

Embodiments described herein include a method executing on a processor, the method comprising receiving a plurality of campaign attributes from an advertiser. The method of an embodiment comprises generating from the plurality of campaign attributes an advertising campaign on at least one online advertising network. The method of an embodiment comprises receiving a plurality of optimizer solutions from a plurality of optimizers. An optimizer solution of an embodiment comprises at least one parameter of the advertising campaign; automatically resolving a conflict between the plurality of optimizer solutions. The method of an embodiment comprises generating an optimized advertising campaign by applying the plurality of optimizer solutions. The optimized advertising campaign of an embodiment comprises optimized advertisements and campaign budget. The method of an embodiment comprises automatically attributing results of the advertising campaign selectively to the plurality of optimizers.

Embodiments described herein include a method executing on a processor, the method comprising: receiving a plurality of campaign attributes from an advertiser; generating from the plurality of campaign attributes an advertising campaign on at least one online advertising network; receiving a plurality of optimizer solutions from a plurality of optimizers, wherein an optimizer solution comprises at least one parameter of the advertising campaign; automatically resolving a conflict between the plurality of optimizer solutions; generating an optimized advertising campaign by applying the plurality of optimizer solutions, wherein the optimized advertising campaign comprises optimized advertisements and campaign budget; and automatically attributing results of the advertising campaign selectively to the plurality of optimizers.

Embodiments described herein include a method executing on a processor, the method comprising receiving a plurality of campaign attributes from an advertiser. The method of an embodiment comprises generating from the plurality of campaign attributes an advertising campaign on at least one online advertising network. The method of an embodiment comprises receiving a plurality of optimizer solutions from a plurality of optimizers. An optimizer solution comprises at least one parameter of the advertising campaign; generating an optimized advertising campaign by applying the plurality of optimizer solutions. The optimized advertising campaign of an embodiment comprises optimized advertisements and campaign budget. The method of an embodiment comprises automatically attributing results of the advertising campaign selectively to the plurality of optimizers by receiving data of a selected advertisement that is selected for viewing. The method of an embodiment comprises determining a sourcing optimizer that is the optimizer that submitted the optimizer solution corresponding to the selected advertisement and generating credit to the sourcing optimizer.

Embodiments described herein include a method executing on a processor, the method comprising: receiving a plurality of campaign attributes from an advertiser; generating from the plurality of campaign attributes an advertising campaign on at least one online advertising network; receiving a plurality of optimizer solutions from a plurality of optimizers, wherein an optimizer solution comprises at least one parameter of the advertising campaign; generating an optimized advertising campaign by applying the plurality of optimizer solutions, wherein the optimized advertising campaign comprises optimized advertisements and campaign budget; automatically attributing results of the advertising campaign selectively to the plurality of optimizers by receiving data of a selected advertisement that is selected for viewing; and determining a sourcing optimizer that is the optimizer that submitted the optimizer solution corresponding to the selected advertisement and generating credit to the sourcing optimizer.

Embodiments described herein include an advertising system comprising an advertising management system (AMS) platform. The advertising system of an embodiment comprises a plurality of campaign attributes. The plurality of campaign attributes of an embodiment are received at the AMS platform from an advertiser via a user interface. The advertising system of an embodiment comprises an advertising campaign generated by the AMS platform from the plurality of campaign attributes and hosted on at least one advertising network. The advertising system of an embodiment comprises a plurality of optimizer solutions comprising at least one parameter of the advertising campaign received at the AMS platform from a plurality of optimizers. The AMS platform of an embodiment generates an optimized advertising campaign by updating the advertising campaign on the at least one advertising network using the plurality of optimizer solutions. The optimized advertising campaign of an embodiment comprises optimized advertisements and advertising campaign budget resulting from the plurality of optimizer solutions.

Embodiments described herein include an advertising system comprising: an advertising management system (AMS) platform; a plurality of campaign attributes, wherein the plurality of campaign attributes are received at the AMS platform from an advertiser via a user interface; an advertising campaign generated by the AMS platform from the plurality of campaign attributes and hosted on at least one advertising network; a plurality of optimizer solutions comprising at least one parameter of the advertising campaign received at the AMS platform from a plurality of optimizers; and wherein the AMS platform generates an optimized advertising campaign by updating the advertising campaign on the at least one advertising network using the plurality of optimizer solutions, wherein the optimized advertising campaign comprises optimized advertisements and advertising campaign budget resulting from the plurality of optimizer solutions.

The AMS platform of an embodiment selectively attributes results of the advertising campaign to the plurality of optimizers.

The AMS platform of an embodiment attributes results by: receiving data of a selected advertisement that is an advertisement selected for viewing via the user interface; determining a sourcing optimizer that is the optimizer that submitted the optimizer solution corresponding to the selected advertisement; and generating credit to the sourcing optimizer as a result of the selected advertisement.

The advertising system of an embodiment comprises directing the user interface to the AMS platform in response to the selected advertisement being selected for viewing and recording the data of the selected advertisement at the AMS platform.

The advertising system of an embodiment comprises redirecting the user interface to a website landing page that corresponds to the selected advertisement.

The AMS platform of an embodiment places a cookie at the user interface, wherein the cookie performs conversion tracking that comprises collecting conversion data of a conversion executed through the user interface.

The AMS platform of an embodiment resolves a conflict between the plurality of optimizer solutions.

The AMS platform of an embodiment resolves the conflict using a first optimizer solution when a first optimizer solution and a second optimizer solution are received and the second optimizer solution is the same as the first optimizer solution.

The advertising system of an embodiment comprises returning the first optimizer solution to a status of available for use by the plurality of optimizers when it ceases to be used by a first optimizer.

The AMS platform of an embodiment resolves the conflict by allowing use of the plurality of optimizer solutions by more than one optimizer, wherein each of the plurality of optimizer solutions comprises a plurality of parameters and at least one parameter is the same between the plurality of optimizer solutions and at least one parameter is different between the plurality of optimizer solutions.

The user interface of an embodiment is used to generate the optimizer solution.

The advertising system of an embodiment comprises generating the optimizer solution by generating an advertisement group that is an optimizer solution, the advertisement group including an advertisement and at least one of a search term and an advertisement placement on the at least one advertising network.

The advertising system of an embodiment comprises generating the optimizer solution by selecting an advertisement from an advertisement database of the AMS platform.

The advertising system of an embodiment comprises generating the optimizer solution by generating an advertisement by adding content to the AMS platform.

The advertising system of an embodiment comprises generating the optimizer solution by specifying a bid price for the at least one parameter of the optimizer solution.

The user interface of an embodiment is used to generate changes to the optimizer solution, wherein the AMS platform propagates the changes to the advertising campaign, wherein the changes include at least one change made to the at least one parameter, wherein the at least one change is at least one of an edit, an addition, and a deletion.

The AMS platform of an embodiment automatically tracks performance data of the advertising campaign and presents the performance data to the plurality of optimizers via the user interface, wherein the performance includes at least one of campaign performance, ad performance, budget spending, conversions, search term impressions, search term clicks, search term conversions, placement impressions, placement clicks, and placement conversions.

The AMS platform of an embodiment simultaneously runs a plurality of advertising campaigns comprising the advertising campaign, and presents to the plurality of optimizers via the user interface the plurality of advertising campaigns and campaign statistics corresponding to each of the plurality of advertising campaigns.

The campaign attributes of an embodiment comprise an optimizer payment system of the advertising campaign.

The optimizer payment system of an embodiment comprises a Pay Per Click (PPC) model, wherein the campaign attributes comprise a click bid price.

The optimizer payment system of an embodiment comprises a Pay Per Action (PPA) model, wherein the campaign attributes comprise a conversion bid price.

The optimizer payment system of an embodiment comprises paying optimizers based on a characteristic of a visitor to the advertising campaign.

The campaign attributes of an embodiment comprise a target value for at least one variable that represents the viewer, wherein the at least one variable is one or more of bounce rate, time on site, percentage of new visitors.

The campaign attributes of an embodiment comprise campaign budget.

The campaign attributes of an embodiment comprise at least one advertisement for use by the plurality of optimizers.

The campaign attributes of an embodiment comprise the at least one advertising network, wherein the at least one advertising network includes at least one online search engine.

The campaign attributes of an embodiment comprise the at least one advertising network and a budget allocation per network, wherein the at least one advertising network includes at least one online search engine.

The campaign attributes of an embodiment comprise advertisement guidelines to be followed when the plurality of optimizers generates advertisement content.

The campaign attributes of an embodiment comprise terms of service.

The at least one parameter of an embodiment is advertisement content.

The at least one parameter of an embodiment is advertisement placement on an advertising network, wherein the advertising network includes an online search engine.

The at least one parameter of an embodiment is a search term to be associated with an advertisement.

The at least one parameter of an embodiment is a bid price.

The at least one parameter of an embodiment comprises an organization scheme for an advertisement group including a plurality of advertisements.

The AMS components can be components of a single system, multiple systems, and/or geographically separate systems. The AMS components can also be subcomponents or subsystems of a single system, multiple systems, and/or geographically separate systems. The AMS components can be coupled to one or more other components (not shown) of a host system or a system coupled to the host system.

The AMS of an embodiment includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of the AMS, and/or provided by some combination of algorithms. The AMS methods described herein can be implemented in one or more of software algorithm(s), programs, firmware, hardware, components, circuitry, in any combination.

The AMS components can be located together or in separate locations. Communication paths couple the AMS components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the AMS described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the AMS include: microcontrollers with memory (such as electronically erasable programmable read only memory (EEPROM)), embedded microprocessors, firmware, software, etc. Furthermore, aspects of the AMS may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the AMS is not intended to be exhaustive or to limit the systems and methods to the precise forms disclosed. While specific embodiments of, and examples for, the AMS are described herein for illustrative purposes, various equivalent modifications are possible within the scope of the systems and methods, as those skilled in the relevant art will recognize. The teachings of the AMS provided herein can be applied to other systems and methods, not only for the systems and methods described above.

The elements and acts of the various embodiments described above can be combined to provide further embodiments. These and other changes can be made to the AMS in light of the above detailed description.

In general, in the following claims, the terms used should not be construed to limit the AMS and corresponding systems and methods to the specific embodiments disclosed in the specification and the claims, but should be construed to include all systems that operate under the claims. Accordingly, the AMS and corresponding systems and methods are not limited by the disclosure, but instead the scope is to be determined entirely by the claims.

While certain aspects of the AMS and corresponding systems and methods are presented below in certain claim forms, the inventors contemplate the various aspects of the AMS and corresponding systems and methods in any number of claim forms. Accordingly, the inventors reserve the right to add additional claims after filing the application to pursue such additional claim forms for other aspects of the AMS and corresponding systems and methods.

What is claimed is:

1. A method executing on a processor, the method comprising:
receiving a plurality of campaign attributes from an advertiser, wherein the plurality of campaign attributes comprise types of advertising permitted by the advertiser and a budget limit per type of advertising;
generating from the plurality of campaign attributes an advertising campaign on at least one advertising network that includes online advertising networks;
receiving a plurality of optimizer solutions from a plurality of optimizers, wherein the plurality of optimizer solutions correspond to the advertising campaign, wherein an optimizer solution comprises at least one parameter of the advertising campaign, wherein the at least one parameter includes a budget allocation between each of the types of advertising permitted by the advertiser; and
generating an optimized advertising campaign by updating the advertising campaign on the at least one advertising network using the plurality of optimizer solutions, wherein the optimized advertising campaign comprises optimized advertisements resulting from the plurality of optimizer solutions.

2. The method of claim 1, wherein the campaign attributes comprise an optimizer payment system of the advertising campaign.

3. The method of claim 2, wherein the optimizer payment system comprises a Pay Per Click (PPC) model, wherein the campaign attributes comprise a click bid price.

4. The method of claim 2, wherein the optimizer payment system comprises a Pay Per Action (PPA) model, wherein the campaign attributes comprise a conversion bid price.

5. The method of claim 1, wherein the optimizer payment system comprises paying optimizers based on a characteristic of a visitor to the advertising campaign, wherein the campaign attributes comprise a target value for at least one variable that represents the viewer, wherein the at least one variable is one or more of bounce rate, time on site, percentage of new visitors.

6. The method of claim 1, wherein the campaign attributes comprise campaign budget.

7. The method of claim 1, wherein the campaign attributes comprise at least one advertisement for use by the plurality of optimizers.

8. The method of claim 1, wherein the campaign attributes comprise the at least one advertising network, wherein the at least one advertising network includes at least one online search engine.

9. The method of claim 1, wherein the campaign attributes comprise the at least one advertising network and a budget allocation per network, wherein the at least one advertising network includes at least one online search engine.

10. The method of claim 1, wherein the campaign attributes comprise advertisement guidelines to be followed when the plurality of optimizers generates advertisement content.

11. The method of claim 1, wherein the at least one parameter is advertisement content.

12. The method of claim 1, wherein the at least one parameter is advertisement placement on an advertising network, wherein the advertising network includes an online search engine.

13. The method of claim 1, wherein the at least one parameter is a search term to be associated with an advertisement.

14. The method of claim 1, wherein the at least one parameter is a bid price.

15. The method of claim 1, wherein the at least one parameter comprises two or more of advertisement content, advertisement placement on an advertising network including an online search engine, a search term to be associated with an advertisement, and a bid price.

16. The method of claim 1, wherein the at least one parameter comprises a set of parameters that includes advertisement content, advertisement placement on an advertising network including an online search engine, and a search term to be associated with an advertisement.

17. The method of claim 1, wherein the at least one parameter comprises an organization scheme for an advertisement group including a plurality of advertisements.

18. The method of claim 1, wherein the at least one parameter comprises an association between an advertisement and a search term.

19. The method of claim 1, comprising automatically resolving a conflict between the plurality of optimizer solutions.

20. The method of claim 1, comprising automatically attributing results of the advertising campaign selectively to the plurality of optimizers, wherein the attributing results of the advertising campaign to the plurality of optimizers comprises:
receiving data of a selected advertisement that is an advertisement selected for viewing via a remote user interface;
determining a sourcing optimizer that is the optimizer that submitted the optimizer solution corresponding to the selected advertisement; and
generating credit to the sourcing optimizer as a result of the selected advertisement.

21. The method of claim 20, comprising:
directing the user interface to an advertising management system (AMS) platform in response to the selected advertisement being selected for viewing; and
recording the data of the selected advertisement at the AMS platform;
redirecting the user interface to a website landing page that corresponds to the selected advertisement, comprising placing a cookie at the user interface for performing conversion tracking, wherein the conversion tracking comprises collecting via the cookie conversion data of a conversion executed with the user interface.

22. The method of claim 1, comprising presenting a user interface to the plurality of optimizers, wherein the user interface is coupled to an advertising management system (AMS) platform, wherein an optimizer generates the optimizer solution at the AMS platform via the user interface.

23. The method of claim 22, wherein generating the optimizer solution comprises generating an advertisement group that is an optimizer solution, the advertisement group including an advertisement and at least one of a search term and an advertisement placement on the at least one advertising network.

24. The method of claim 22, wherein generating the optimizer solution comprises at least one of selecting an advertisement from an advertisement database of the AMS platform and generating an advertisement by adding content to the AMS platform.

25. The method of claim 22, wherein generating the optimizer solution comprises specifying a bid price for the at least one parameter of the optimizer solution.

26. The method of claim 1, comprising:
automatically tracking performance data of the advertising campaign, wherein the performance includes at least one of campaign performance, ad performance, budget spending, conversions, search term impressions, search term clicks, search term conversions, placement impressions, placement clicks, and placement conversions; and
presenting to the plurality of optimizers via a user interface the performance data.

27. An advertising system comprising:
an advertising management system (AMS) platform;
a plurality of campaign attributes, wherein the plurality of campaign attributes are received at the AMS platform from an advertiser via a user interface, wherein the plurality of campaign attributes comprise types of advertising permitted by the advertiser and a budget limit per type of advertising;
an advertising campaign generated by the AMS platform from the plurality of campaign attributes and hosted on at least one advertising network;
a plurality of optimizer solutions comprising at least one parameter of the advertising campaign received at the AMS platform from a plurality of optimizers, wherein an optimizer solution comprises at least one parameter of the advertising campaign, wherein the at least one parameter includes a budget allocation between each of the types of advertising permitted by the advertiser; and
wherein the AMS platform generates an optimized advertising campaign by updating the advertising campaign on the at least one advertising network using the plurality of optimizer solutions, wherein the optimized advertising campaign comprises optimized advertisements resulting from the plurality of optimizer solutions.

28. The advertising system of claim 27, wherein the AMS platform selectively attributes results of the advertising campaign to the plurality of optimizers by:
receiving data of a selected advertisement that is an advertisement selected for viewing via the user interface;
determining a sourcing optimizer that is the optimizer that submitted the optimizer solution corresponding to the selected advertisement; and
generating credit to the sourcing optimizer as a result of the selected advertisement.

29. The advertising system of claim 28, comprising:
directing the user interface to the AMS platform in response to the selected advertisement being selected for viewing and recording the data of the selected advertisement at the AMS platform; and
redirecting the user interface to a website landing page that corresponds to the selected advertisement, wherein the AMS platform places a cookie at the user interface, wherein the cookie performs conversion tracking that comprises collecting conversion data of a conversion executed through the user interface.

30. The advertising system of claim 27, wherein the user interface is used to generate the optimizer solution.

31. The advertising system of claim 30, comprising generating the optimizer solution by selecting an advertisement from an advertisement database of the AMS platform.

32. The advertising system of claim 30, comprising generating the optimizer solution by generating an advertisement by adding content to the AMS platform.

33. The advertising system of claim 30, comprising generating the optimizer solution by specifying a bid price for the at least one parameter of the optimizer solution.

34. The advertising system of claim 30, wherein the user interface is used to generate changes to the optimizer solution, wherein the AMS platform propagates the changes to the advertising campaign, wherein the changes include at least one change made to the at least one parameter, wherein the at least one change is at least one of an edit, an addition, and a deletion.

35. The advertising system of claim 27, wherein the AMS platform automatically tracks performance data of the advertising campaign and presents the performance data to the plurality of optimizers via the user interface, wherein the performance includes at least one of campaign performance, ad performance, budget spending, conversions, search term impressions, search term clicks, search term conversions, placement impressions, placement clicks, and placement conversions.

36. The advertising system of claim 27, wherein the campaign attributes comprise an optimizer payment system of the advertising campaign.

37. The advertising system of claim 36, wherein the optimizer payment system comprises a Pay Per Click (PPC) model, wherein the campaign attributes comprise a click bid price.

38. The advertising system of claim 36, wherein the optimizer payment system comprises a Pay Per Action (PPA) model, wherein the campaign attributes comprise a conversion bid price.

39. The advertising system of claim 27, wherein the optimizer payment system comprises paying optimizers based on a characteristic of a visitor to the advertising campaign.

40. The advertising system of claim 27, wherein the campaign attributes comprise campaign budget.

41. The advertising system of claim 27, wherein the campaign attributes comprise at least one advertisement for use by the plurality of optimizers.

42. The advertising system of claim 27, wherein the campaign attributes comprise the at least one advertising network, wherein the at least one advertising network includes at least one online search engine.

43. The advertising system of claim 27, wherein the campaign attributes comprise the at least one advertising network and a budget allocation per network, wherein the at least one advertising network includes at least one online search engine.

44. The advertising system of claim 27, wherein the campaign attributes comprise advertisement guidelines to be followed when the plurality of optimizers generates advertisement content.

45. The advertising system of claim 27, wherein the at least one parameter is advertisement content.

46. The advertising system of claim 27, wherein the at least one parameter is advertisement placement on an advertising network, wherein the advertising network includes an online search engine.

47. The advertising system of claim 27, wherein the at least one parameter is a search term to be associated with an advertisement.

48. The advertising system of claim 27, wherein the at least one parameter is a bid price.

49. The advertising system of claim 27, wherein the at least one parameter comprises an organization scheme for an advertisement group including a plurality of advertisements.
